(19) United States
(12) Patent Application Publication
(10) Pub. No.: US 2002/0024775 A1
(43) Pub. Date: Feb. 28, 2002

(54) Spin valve thin film magnetic element and method of manufacturing the same

(75) Inventor: Naoya Hasegawa, Niigata-ken (JP)

Correspondence Address: Brinks Hofer Gilson & Lione, P.O. Box 10395, Chicago, IL, 60610, US

(73) Assignee: Alps Electric Co., Ltd.

(21) Appl. No.: 09/934,293

(22) Filed: Aug. 21, 2001

(30) Foreign Application Priority Data
Aug. 30, 2000 (JP) 2000-261945

(51) Int. Cl. G11B 5/39; B44C 1/22

(52) U.S. Cl. 360/314; 360/324.1; 360/322; 216/22; 29/603.18

(57) ABSTRACT

The present invention provides a spin valve thin film magnetic element capable of preventing the occurrence of side reading, and a method of manufacturing the same. In the spin valve thin film magnetic element, nonmagnetic conductive layers, pinned magnetic layers and antiferromagnetic layers are laminated on both sides of a free magnetic layer in the thickness direction to form a laminate on a substrate. Also, bias layers and lead layers are provided on both sides of the laminate in the track width direction. Of the antiferromagnetic layers, at least the antiferromagnetic layer apart from the substrate is made narrower than the free magnetic layer in the track width direction to form lead connecting portions of the laminate on both sides of the narrow antiferromagnetic layer in the track width direction. The lead layers are formed to extend from both sides of the laminate in the track width direction to the center thereon and to be connected to the laminate 12 through the lead connecting portions.

### BACKGROUND OF THE INVENTION

1. Field of the Invention

The present invention relates to a spin valve thin film magnetic element and a thin film magnetic head, and methods of manufacturing the thin film magnetic head and the spin valve thin film magnetic element. Particularly, the present invention relates to a technique suitably used for a dual spin valve thin film magnetic element in which lead layers are formed to adhere to a dual laminate so that the lead layers extend from both sides of the laminate in the track width direction to the center thereof.

2. Description of the Related Art

A spin valve thin film magnetic element is a GMR (Giant Magnetoresistive) element exhibiting a giant magnetoresistive effect, and adapted to detect a recording magnetic field from a recording medium such as a hard disk or the like.

Among GMR elements, the spin valve thin film magnetic element has the advantages that it has a relatively simple structure and a high rate of change in resistance with an external magnetic field, and thus causes a change in resistance with a weak magnetic field.

FIG. 22 is a sectional view showing the structure of an example of a conventional spin valve thin film magnetic element as viewed from the side (ABS) facing a recording medium.

The spin valve thin film magnetic element shown in FIG. 22 is a so-called dual spin valve thin film magnetic element in which a nonmagnetic conductive layer, a pinned magnetic layer, and an antiferromagnetic layer are laminated on either side of a free magnetic layer in the thickness direction.

In FIG. 22, the Z direction coincides with the moving direction of a magnetic recording medium such as a hard disk or the like, the Y direction coincides with the direction of a leakage magnetic field from the magnetic recording medium, and the X1 direction coincides with the track width direction of the spin valve thin film magnetic element.

The conventional spin valve thin film magnetic element 301 shown in FIG. 22 comprises a laminate 312 formed by laminating in turn, on a substrate 302, an underlying layer 303 made of Ta, a first antiferromagnetic layer 304, a first pinned magnetic layer 305, a first nonmagnetic conductive layer 306 made of Cu, a free magnetic layer 307, a second nonmagnetic conductive layer 308 made of Cu, a second pinned magnetic layer 309, a second antiferromagnetic layer 310 and a protecting layer 311 made of Ta; a pair of bias layers 332 made of a CoPt alloy or the like and formed on both sides of the laminate 312; and a pair of lead layers 334 made of Cu or the like and formed on the bias layers 332.

The first pinned magnetic layer 305 comprises a laminate of a first ferromagnetic pinned layer 305a, a first nonmagnetic intermediate layer 305b and a second ferromagnetic pinned layer 305c. The thickness of the second ferromagnetic pinned layer 305c is larger than that of the first ferromagnetic pinned layer 305a.

The magnetization direction of the first ferromagnetic pinned layer 305a is pinned in the Y direction by an exchange coupling magnetic field with the first antiferromagnetic layer 304, and the second ferromagnetic pinned layer 305c is antiferromagnetically coupled with the first ferromagnetic pinned layer 305a so that the magnetization direction is pinned in the direction opposite to the Y direction.

In this way, the magnetization directions of the first and second ferromagnetic pinned layers 305a and 305c are antiparallel to each other, and thus the magnetic moments of both layers are canceled by each other. However, since the second ferromagnetic pinned layer 305c is thicker than the first ferromagnetic pinned layer 305a, magnetization (magnetic moment) of the second ferromagnetic pinned layer 305c slightly remains to fix the net magnetization direction of the entire first pinned magnetic layer 305 in the Y direction shown in the drawing.

The second pinned magnetic layer 309 comprises a laminate of a third ferromagnetic pinned layer 309a, a second nonmagnetic intermediate layer 309b and a fourth ferromagnetic pinned layer 309c. The thickness of the third ferromagnetic pinned layer 309a is larger than that of the fourth ferromagnetic pinned layer 309c.

The magnetization direction of the fourth ferromagnetic pinned layer 309c is pinned in the Y direction by an exchange coupling magnetic field with the second antiferromagnetic layer 310, and the third ferromagnetic pinned layer 309a is antiferromagnetically coupled with the fourth ferromagnetic pinned layer 309c so that the magnetization direction is pinned in the direction opposite to the Y direction.

In this way, like the first pinned magnetic layer 305, the magnetic moments of the third and fourth ferromagnetic pinned magnetic layers 309a and 309c are canceled by each other. However, since the third ferromagnetic pinned layer 309a is thicker than the fourth ferromagnetic pinned layer 309c, magnetization (magnetic moment) of the third ferromagnetic pinned layer 309a slightly remains to fix the net magnetization direction of the entire second pinned magnetic layer 309 in the direction opposite to the Y direction shown in the drawing.

Therefore, in the first and second pinned magnetic layers 305 and 309, the first to fourth ferromagnetic pinned layers 305a, 305c, 309a, and 309c are antiferromagnetically coupled with each other, and magnetization of each of the second and third ferromagnetic pinned layers 305c and 309a remains, thereby exhibiting a synthetic ferrimagnetic pinned state.

The free magnetic layer 307 comprises a laminate of a first anti-diffusion layer 307a made of Co or the like, a ferromagnetic free layer 307b made of a NiFe alloy, and a second anti-diffusion layer 307c made of Co or the like. The first and second anti-diffusion layers 307a and 307c have the effect of preventing mutual diffusion between these anti-diffusion layers and the adjacent first and second nonmagnetic conductive layers 306 and 308, respectively, and increasing the rate of change in resistance (ΔR/R).

The magnetization direction of the free magnetic layer 307 is oriented in the X1 direction shown in the drawing by a bias magnetic field of each of the bias layers 332.

Therefore, the magnetization direction of the free magnetic layer 307 crosses the magnetization directions of the first and second pinned magnetic layers 305 and 309.

The lead layers 334 are laminated on the bias layers 332 to extend from both sides of the laminate 312 in the X1 direction to the center of the laminate 312 so that the lead layers 334 are partially overlaid on both ends of the laminate 312 in the X1 direction to be adhered to the laminate 312. The portions of the lead layers 334, which adhered to the laminate 312, are referred to as “overlay portions 334a”. The overlay portions 334a are arranged with a space Tw therebetween on the laminate 312.

The first antiferromagnetic layer 304 is formed to extend toward both sides in the X₁ direction beyond the first pined magnetic layer 305 and the free magnetic layer 307.

Also, bias underlying layers 331 made of Ta or Cr are respectively laminated between the extensions 304a of the first antiferromagnetic layer 304 and the bias layers 332. Furthermore, intermediate layers 333 made of Ta or Cr are respectively laminated between the bias layers 332 and the lead layers 334.

In the spin valve thin film magnetic element 301, when a sensing current is supplied to the laminate 312 from the lead layers 334, and a leakage magnetic field is applied from a magnetic recording medium in the Y direction, the magnetization direction of the free magnetic layer 307 is changed from the X1 direction to the Y direction. Therefore, the electrical resistance value changes based on the relation between the change of the magnetization direction of the free magnetic layer 307 and the magnetization directions of the first and second pinned magnetic layers 305 and 309 (magnetoresistive (MR) effect), and the leakage magnetic field from the magnetic recording medium is detected by a voltage change based on the change in the electrical resistance value.

In the spin valve thin film magnetic element 301, the sensing current is supplied to the laminate 312 from each of the lead layers 334. However, as shown in FIG. 22, the sensing current J (arrow J) is mainly applied to the laminate 312 from the vicinity of the tip 334b of each of the overlay portions 334a.

Therefore, the sensing current is most liable to flow to the region of the laminate 312, which is not covered with the overlay portions 334a, and thus the sensing current is concentrated in this region, thereby substantially increasing the magnetoresistive (MR) effect and increasing the detection sensitivity of the leakage magnetic field from the magnetic recording medium. Thus, the region which is not covered with the overlay portions 334a is referred to as a “sensitive zone S”, as shown in FIG. 22.

On the other hand, in the zones covered with the overlay portions 334a, the sensing current is significantly decreased to substantially decrease the magnetoresistive (MR) effect and decrease the detection sensitivity of the leakage magnetic field from the magnetic recording medium. The regions covered with the overlay portions 334a are referred to as “insensitive zones N”.

In this way, the overlay portions 334a of the lead layers 334 are adhered to portions of the laminate 312 to form the region (sensitive zone S) which substantially contributes to reproduction of a record magnetic field from the magnetic recording medium, and the regions (dead zones N) which do not substantially contribute to reproduction of a record magnetic field from the magnetic recording medium. The width Tw of the sensitive zone S corresponds to the track width of the spin valve thin film magnetic element 301, and thus it is possible to comply with a narrower track.

However, in the conventional spin valve thin film magnetic element 301, the overlay portions 334a are adjacent to the second antiferromagnetic layer 310, and the first and second pinned magnetic layers 305 and 309, the free magnetic layer 307 and the first and second nonmagnetic conductive layers 306 and 308 are present on the substrate side of the second antiferromagnetic layer 310. Therefore, in order to flow the sensing current to the first and second pinned magnetic layers 305 and 309, the free magnetic layer 307 and the first and second nonmagnetic conductive layers 306 and 308 from the overlay portions 334a, the sensing current inevitably flows through the second antiferromagnetic layer 310.

The second antiferromagnetic layer 310 comprises a IrMn alloy, a FeMn alloy, a NiMn alloy, of the like, which has a resistivity of about 200 μΩ·cm which is ten times as large as the resistivity (the order of 10 μΩ·cm) of Co and the NiFe alloy constituting the first to fourth ferromagnetic pinned layers 305a, 305c, 309a and 309c, and hundred times as large as the resistivity (the order of 1 μΩ·cm) of Cu, which constitutes the first and second nonmagnetic conductive layers 306 and 308.

Since the sensing current J flowing from the overlay portions 34a is subjected to high resistance because of the high resistivity of the second antiferromagnetic layer 310, the component of the shunt J′ flowing from the lead layers 334 directly to the substrate side of the second antiferromagnetic layer 310 through the bias layers 332 becomes a considerable magnitude, as shown in FIG. 22.

As a result, the shunt J′ of the sensing current flows into the dead zones N to express a change in magnetoresistance in the dead zones N with an external magnetic field, thereby reproducing a signal on the recording track of the magnetic recording medium corresponding to the dead zones N.

Particularly, when the recording track width and recording track pitch of the magnetic recording medium are decreased to narrow the track in order to increase the recording density, side reading occurs. Namely, information on a recording track adjacent to a recording track on which information is to be read in the sensitive zone is read out in the dead zones N to cause noise in the output signal, possibly causing error.

Furthermore, there is the fundamental demand for further improving the output characteristics and sensitivity of the spin valve thin film magnetic element.

### SUMMARY OF THE INVENTION

The present invention has been achieved in consideration of the above-described situation, and objects of the present invention are the following:

(1) To improve the output characteristics of a spin valve thin film magnetic element.

(2) To prevent the occurrence of side reading.

(3) To provide a method of manufacturing the spin valve thin film magnetic element.

(4) To provide a thin film magnetic head comprising the spin valve thin film magnetic element.

In order to achieve the objects, the present invention provides the constructions below.

The present invention provides a spin valve thin film magnetic element comprising a pair of nonmagnetic conductive layers, a pair of pinned magnetic layers, and a pair of antiferromagnetic layers for respectively pinning the magnetization directions of the pair of pinned magnetic layers, which are laminated in turn on both sides of a free magnetic layer in the thickness direction to form a laminate on a substrate; a pair of bias layers located on both sides of the laminate in the track width direction, for orienting the magnetization direction of the free magnetic layer in the direction crossing the magnetization direction of each of the pinned magnetic layers; and a pair of lead layers laminated on the bias layers, for supplying a sensing current to the laminate; wherein of the pair of antiferromagnetic layers, at least the antiferromagnetic layer away from the substrate is made narrower than the free magnetic layer in the track width direction to form lead connecting portions of the laminate on both sides of the narrow antiferromagnetic layer in the track width direction, and the pair of lead layers are formed to extend from both sides of the laminate in the track width direction to the center of thereof and to be connected to the laminate through the pair of lead connecting portions.

In the spin valve thin film magnetic element, the lead layers are connected to the lead connecting portions formed on both sides of the narrow antiferromagnetic layer in the track width direction so that the sensing current flows directly to the pinned magnetic layers from the lead layers without passing through the antiferromagnetic layer having high resistivity, thereby decreasing a shunt component of the sensing current, which flows to the laminate through the bias layers.

Therefore, the sensing current can be concentrated in the central portion of the laminate which is not covered with the lead layers, and the change in voltage in this portion can be increased to improve the output characteristics of the spin valve thin film magnetic element.

Since the shunt component of the sensing current can be decreased, substantially no magnetoresistive effect is exhibited in the portions (both end portions of the laminate in the track width direction), which are covered with the lead layers, to avoid the detection of a leakage magnetic field from the recording track of the recording magnetic medium in those portions. Therefore, it is possible to prevent side reading of the spin valve thin film magnetic element.

In the spin valve thin film magnetic element of the present invention, in addition to the narrow antiferromagnetic layer, at least a portion or the whole of the pinned magnetic layer adjacent to the antiferromagnetic layer may be made narrower than the free magnetic layer to form lead connecting portions of the laminate on both sides of the narrow antiferromagnetic layer and pinned magnetic layer, and the pair of lead layers are formed to extend from both sides of the laminate in the track width direction to the center thereof and to be connected to the laminate through the pair of lead connecting portions.

In the spin valve thin film magnetic element, the lead layers are connected to the lead connecting portions formed on both sides of the narrow antiferromagnetic layer and pinned magnetic layer in the track width direction, and thus the sensing current flows directly to the nonmagnetic conductive layers having low resistivity, thereby decreasing the shunt component of the sensing current. It is thus possible to more effectively suppress side reading of the spin valve thin film magnetic element.

In the spin valve thin film magnetic element of the present invention, in addition to the narrow antiferromagnetic layer, the pinned magnetic layer adjacent to the narrow antiferromagnetic layer and a portion the nonmagnetic conductive layer adjacent to the pinned magnetic layer may be made narrower than the free magnetic layer to form lead connecting portions of the laminate on both sides of the narrow antiferromagnetic layer, pinned magnetic layer and nonmagnetic conductive layer, and the pair of lead layers are formed to extend from both sides of the laminate in the track width direction to the center thereof and to be connected to the laminate through the pair of lead connecting portions.

In the spin valve thin film magnetic element, the lead layers are connected to the lead connecting portions formed on both sides of the narrow antiferromagnetic layer and pinned magnetic layer and the narrow portion of the nonmagnetic conductive layer in the track width direction, and thus the sensing current flows directly to the nonmagnetic conductive layers having low resistivity, thereby further decreasing the shunt component of the sensing current. It is thus possible to more effectively suppress side reading of the spin valve thin film magnetic element.

In the spin valve thin film magnetic element of the present invention, the pair of the connecting portions preferably respectively comprise notch portions formed on the side apart from the substrate to be located at both ends of the laminate in the track width direction, and the width of each of the pair of the lead connecting portions in the track width direction is preferably in the range of 0.03 to 0.5 μm.

In the spin valve thin film magnetic element, the lead connecting portions respectively comprise the notch portions, and thus the lead layers are respectively fitted into the notch portions for connection to decrease the steps between the laminate and the lead layers, thereby decreasing the gap width of the spin valve thin film magnetic element. Also, when an insulating layer is further laminated on the spin valve thin film magnetic element, the possibility of producing pin holes or the like in the insulating layer can be prevented, thereby improving the insulating performance of the spin valve thin film magnetic element.

Since the width of each the lead connecting portions is in the range of 0.03 to 0.5 μm, the contact area between the lead connecting portions and the laminate can be increased to permit the sensing current to efficiently flow into the laminate.

In the spin valve thin film magnetic element of the present invention, the pair of bias layers are adjacent to the free magnetic layer to be located at the same layer position as at least the free magnetic layer, and the upper surfaces of the pair of bias layers are joined to the laminate at positions nearer to the substrate than the lead connecting portions so that only the pair of lead layers are connected to the pair of lead connecting portions.

In the spin valve thin film magnetic element, only the lead layers are respectively connected to the lead connecting portions, while the bias layers are not connected to the lead connecting portions. Therefore, the contact area between the lead layers and the laminate can be increased to decrease the shunt component and further improve the output characteristics of the spin valve thin film magnetic element.

Also, the bias layers are located at the same layer position as the free magnetic layer, and thus a strong magnetic field can easily be applied to the free magnetic layer, thereby easily bringing the free magnetic layer in a single magnetic domain state and decreasing Barkhausen noise.

The terms “at the same layer position as the free magnetic layer” represent the state in which the free magnetic layer is held between the pair of the bias layers in the track width direction so that at least the bias layers are magnetically connected to the free magnetic layer. This state includes the state in which the thickness of each of the junctions between the bias layers and the free magnetic layer is smaller than the thickness of the free magnetic layer.

The term “adjacent” means not only that layers are connected directly to each other, but also that layers are connected through, for example, a bias underlying layer, an intermediate layer, or the like.

In the spin valve thin film magnetic element of the present invention, each of the pair of the pinned magnetic layers preferably comprises a laminate of at least two ferromagnetic layers and a nonmagnetic intermediate layer inserted between these ferromagnetic layers, and the magnetization directions of the adjacent ferromagnetic layers are antiparallel to each other to bring the whole pinned magnetic layer into a ferrimagnetic state.

In the spin valve thin film magnetic element, each of the pinned magnetic layers is a layer exhibiting a so-called synthetic ferrimagnetic pinned state, and thus each of the pinned magnetic layer can be stabilized by strongly pinning the magnetization direction thereof.

In the spin valve thin film magnetic element of the present invention, the antiferromagnetic layer near to the substrate is preferably formed to extend beyond the free magnetic layer in the track width direction so that the bias layers are respectively laminated on the extensions of the antiferromagnetic layer.

In the spin valve thin film magnetic layer, the antiferromagnetic layer near to the substrate extends beyond the pined magnetic layer and the free magnetic layer in the track width direction, and thus the height of the bias layers can be controlled to the same layer position as the free magnetic layer, thereby permitting application of a strong bias magnetic field to the free magnetic layer.

Furthermore, in the spin valve thin film magnetic element of the present invention, the bias layers are preferably respectively laminated, through bias underlying layers made of Ta or Cr, on the extensions of the antiferromagnetic layer located near to the substrate.

In the spin valve thin film magnetic element, the bias underlying layers are respectively laminated between the extensions of the antiferromagnetic layer and the bias layers, and thus magnetic coupling between the antiferromagnetic layer and the bias layers can be prevented. Also, the crystal orientation of the bias layers can be adjusted to improve the magnetic properties (coercive force and remanence ratio when the bias layers comprise a hard magnetic material) of the bias layers.

In the spin valve thin film magnetic element of the present invention, each of the pair of the antiferromagnetic layers comprises any of XMn alloys and PtX′Mn alloys (wherein X represents one element selected from Pt, Pd, Ir, Rh, Ru, and Os, and X′ represents at least one element selected from Pd, Cr, Ru, Ni, Ir, Rh, Os, Au, Ag, Ne, Ar, Xe and Kr).

In the spin valve thin film magnetic element of the present invention, each of the pair of the antiferromagnetic layers comprises the XMn alloy or PtX′Mn alloy which exhibits a high exchange coupling magnetic field and a sufficient exchange coupling magnetic field even at a relatively high temperature, thereby stabilizing the operation of the sin valve thin film magnetic element, particularly the operation at a relatively high temperature.

In the spin valve thin film magnetic element of the present invention, the laminate comprises a central sensitive zone which has high reproduction sensitivity and substantially can exhibit the magnetoresistive effect, and dead zones which are formed on both sides of the sensitive zone in the track width direction and have low reproduction sensitivity, and which substantially cannot exhibit the magnetoresistive effect. The pair of lead connecting portions formed at both ends of the laminate are formed on the dead zones of the laminate, and the pair of lead layers are formed to extend from both sides of the laminate in the track width direction to the dead zones.

In the spin valve thin film magnetic element, the lead layers are formed to extend from both sides of the laminate in the track width direction to the dead zones, and thus the sensing current flowing from the lead layers can be concentrated in the sensitive zone located between the pair of lead layers. Therefore, the width of the sensitive zone between the pair of lead layers can be caused to correspond to the track width of the spin valve thin film magnetic element.

Therefore, the track width of the spin valve thin film magnetic element can be defined by the space between the pair of lead layers formed to adhere to the dead zones, and thus the track width of the spin valve thin film magnetic element can be narrowed by decreasing the space between the pair of the lead layers.

The range of the sensitive zone of the laminate can be determined by a micro track profile method. Namely, the sensitive zone is defined as a zone in which the obtained signal strength is 50% or more of the maximum signal strength of the reproduced signal obtained by scanning the spin valve thin film magnetic element on a micro track on which a signal is recorded.

The dead zones of the laminate are located on both sides of the sensitive zone and defined as zones in which the signal strength is 50% or less of the maximum strength.

A thin film magnetic head of the present invention comprises the above-described spin valve thin film magnetic element as an element for reading magnetic information.

A flying magnetic head of the present invention comprises the thin film magnetic head provided on a slider.

The thin film magnetic head of the present invention comprises the spin valve thin film magnetic element serving as the reading element, thereby exhibiting the high reproduced output of magnetic information, and the low probability of producing side reading.

The flying magnetic head of the present invention comprises the thin film magnetic head, thereby exhibiting the high reproduced output of magnetic information, and the low probability of producing side reading.

A method of manufacturing a spin valve thin film magnetic element of the present invention comprises the laminated film forming step of laminating in turn an antiferromagnetic layer, a pinned magnetic layer, a nonmagnetic conductive layer, a free magnetic layer, another nonmagnetic conductive layer, another pinned magnetic layer and another antiferromagnetic layer on a substrate to form a laminated film; the resist forming step of forming a lift off resist on the laminated film, the resist comprising a butting surface in contact with the laminated film and both side surfaces holding the contact surface therebetween, and a pair of notches provided on both sides of the butting surface in the track width direction to be located between the butting surface and both side surfaces; the laminate forming step of entirely or partially etching the laminated film outside both side surfaces of the lift off resist in the track width direction by irradiating the laminated film with an etching particle beam in the direction at an angle θ₁ with the substrate to form a laminate having a substantially trapezoidal sectional shape; the bias layer forming step of depositing other sputtered particles on both sides of the laminate in the direction at an angle θ₂ (however, θ₂>θ₁) with the substrate to laminate a pair of bias layers to the same layer position as at least the free magnetic layer; the lead connecting portion forming step of etching at lest the portions of the other antiferromagnetic layer corresponding to the pair of notches by irradiating the laminate with another etching particle beam in the direction at an angle θ₃ (however, θ₁>θ₃) with the substrate to form a pair of lead connecting portions; and the lead layer forming step of depositing other sputtered particles on the laminate and the bias layers in the direction at an angle θ₃ with the substrate to form a pair of lead layers which extend from both sides of the laminate in the track width direction to the center thereof to be connected to the laminate through the pair of lead connecting portions.

The method of manufacturing a spin valve thin film magnetic element of the present invention comprises the laminate forming step of irradiating the laminated film with an etching particle beam in the direction at an angle θ₁ with the substrate to form the laminate having a substantially trapezoidal sectional shape, and the lead connecting portion forming step of irradiating the laminate with another etching particle beam in the direction at an angle θ₃ (however, θ₁>θ₃) with the substrate to form the pair of lead connecting portions corresponding to the pair of notches of the lift off resist. Therefore, the laminate and the lead connecting portions can be formed by using only one lift off resist, thereby shortening the process for manufacturing the spin valve thin film magnetic element.

Since the antiferromagnetic layer is etched to form the lead connecting portions, and the lead layers are formed to be connected to the lead connecting portions, the lead layers can be connected directly to the pinned magnetic layer. Therefore, it is possible to manufacture a spin valve thin film magnetic element in which the sensing current can be applied to the laminated without flowing into the antiferromagnetic layer.

In the method of manufacturing a spin valve thin film magnetic element of the present invention, besides the portions of the antiferromagnetic layer corresponding to the notches of the lift off resist, the pinned magnetic layer adjacent to the antiferromagnetic layer are partially or entirely etched corresponding to the notches to form the lead connecting portions. Therefore, the lead layers can be connected to portions of the pinned magnetic layer or the nonmagnetic conductive layer, to manufacture a spin valve thin film magnetic element in which the sensing current can be efficiently applied to the laminate.

Furthermore, the method of manufacturing a spin valve thin film magnetic element of the present invention may comprise the lead connecting portion forming step of etching the other antiferromagnetic layer and the other pinned magnetic layer corresponding to the pair of notches, and partially etching the other nonmagnetic conductive layer corresponding to the pair of notches to form a pair of lead connecting portions.

In the method of manufacturing a spin valve thin film magnetic element of the present invention, besides the portions of the antiferromagnetic layer which are located corresponding to the notches of the lift off resist, the pinned magnetic layer adjacent to the antiferromagnetic layer, and the nonmagnetic conductive layer may be etched corresponding to the notches of the lift off resist to form the lead connecting portions. Therefore, the lead layers can be connected to the nonmagnetic conductive layer, thereby manufacturing a spin valve thin film magnetic element in which the sensing current can be more efficiently applied to the laminate.

In the method of manufacturing a spin valve thin film magnetic element of the present invention, the laminate forming step preferably comprises etching the laminated film outside both side surfaces of the lift off resist in the track width direction to leave a portion of the antiferromagnetic layer adjacent to the substrate.

In the method of manufacturing a spin valve thin film magnetic element, the laminated film is etched to leave a portion of the antiferromagnetic layer adjacent to the substrate, and thus the height of the bias layers can be controlled to the same layer position as the free magnetic layer, thereby permitting application of a strong bias magnetic field to the free magnetic layer.

In the method of manufacturing a spin valve thin film magnetic element of the present invention, the bias layer forming step comprises forming the bias layers and depositing sputtered particles at the angle θ₁ to form intermediate layers made of Ta or Cr on the bias layers, and the lead connecting portion forming step comprises forming the lead connecting portions and, at the same time, etching a portion of the intermediate layer.

In the method of manufacturing a spin valve thin film magnetic element of the present invention, the intermediate layers are formed on the bias layers, and partially etched during formation of the lead connecting portions. Therefore, the intermediate layers can be located nearer to the substrate than at least the lead connecting portions, thereby permitting connection of only the lead layers to the lead connecting portions.

Since the bias layers are coated with the intermediate layers, the bias layers are not etched during formation of the lead connecting portions to prevent the probability that the bias layers are thinned to decrease the bias magnetic field.

In the method of manufacturing a spin valve thin film magnetic element of the present invention, preferably, the angle θ₁ is in the range of 60 to 85°, the angle θ₂ is in the range of 70 to 90°, and the angle θ₃ is in the range of 40 to 70°.

In the method of manufacturing a spin valve thin film magnetic element of the present invention, the widths of the pair of lead connecting portions in the track width direction are respectively defined by the widths of the notches of the lift off resist in the track width direction.

In the method of manufacturing a spin valve thin film magnetic element, the widths of the pair of lead connecting portions in the track width direction can be respectively defined by the widths of the notches of the lift off resist in the track width direction, and thus the dimension of each of the lead connecting portions in the track width direction can be precisely controlled. Therefore, the contact area of the lead layers in the lead connecting portions can be controlled so that the sensing current can be efficiently applied to the laminate.

A method of manufacturing a spin valve thin film magnetic element according to another aspect of the present invention comprises the laminated film forming step of laminating in turn an antiferromagnetic layer, a pinned magnetic layer, a nonmagnetic conductive layer, a free magnetic layer, another nonmagnetic conductive layer, another pinned magnetic layer and another antiferromagnetic layer on a substrate to form a laminated film; the first resist forming step of forming a first lift off resist on the laminated film, the first resist comprising a butting surface in contact with the laminated film and both side surfaces holding the contact surface therebetween, and a pair of notches provided on both sides of the butting surface in the track width direction to be located between the butting surface and both side surfaces; the laminate forming step of entirely or partially etching the laminated film outside both side surfaces of the first lift off resist in the track width direction by irradiating the laminated film with an etching particle beam in the direction at an angle θ₄ with the substrate to form a laminate having a substantially trapezoidal sectional shape; the bias layer forming step of depositing other sputtered particles on both sides of the laminate in the direction at an angle θ₅ (however, θ₅>θ₄) with the substrate to laminate a pair of bias layers to the same layer position as at least the free magnetic layer; the second lift off resist forming step of removing the first lift off resist and forming a second lift off resist at substantially the center of the top of the laminate, the second resist comprising a butting surface narrower than the butting surface of the first lift off resist and both side surfaces holding the narrow butting surface therebetween, and a pair of notches provided on both sides of the narrow butting surface in the track width direction to be located between the butting surface and both side surfaces; the lead connecting portion forming step of etching at lest the portions of the other antiferromagnetic layer outside both side surfaces of the second lift off resist in the track width direction by irradiating the laminate with another etching particle beam in the direction at an angle θ₆ with the substrate to form a pair of lead connecting portions; and the lead layer forming step of depositing still other sputtered particles on the laminate and the bias layers in the direction at an angle θ₆ with the substrate to form a pair of lead layers which extend from both sides of the laminate in the track width direction to the center thereof to be connected to the laminate through the pair of lead connecting portions.

In the method of manufacturing a spin valve thin film magnetic element, the laminate having a substantially trapezoidal sectional shape is formed by using the first lift off resist, and the lead connecting portions are formed by using the second lift off resist. Therefore, the width of the laminate in the track width direction and the width of each of the lead connecting portions in the track width direction can be respectively precisely controlled to permit easy manufacture of a spin valve thin film magnetic element having a narrow track and the low probability of occurrence of side reading.

In the method of manufacturing a spin valve thin film magnetic element of the present invention, the lead connecting portion forming step comprises etching the other antiferromagnetic layer outside both side surfaces of the second lift off resist in the track width direction, and partially or entirely etching the other pinned magnetic layer outside both side surfaces of the second lift off resist in the track width direction to form a pair of lead connecting portions.

In the method of manufacturing a spin valve thin film magnetic element, besides the portions of the other antiferromagnetic layer outside both sides surfaces of the lift off resist in the track width direction, the pinned magnetic layer are partially or entirely etched outside both sides surfaces of the lift off resist in the track width direction to form the lead connecting portions. Therefore, the lead layers can be connected to a portion of the pinned magnetic layer or the nonmagnetic conductive layer, thereby permitting manufacture of a spin valve thin film magnetic element in which the sensing current can be efficiently supplied to the laminate.

In the method of manufacturing a spin valve thin film magnetic element of the present invention, the lead connecting portion forming step comprises etching the other antiferromagnetic layer and the other pinned magnetic layer outside both side surfaces of the second lift off resist in the track width direction, and partially etching the other nonmagnetic conductive layer outside both side surfaces of the second lift off resist in the track width direction to form a pair of lead connecting portions.

In the method of manufacturing a spin valve thin film magnetic element, besides the portions of the other antiferromagnetic layer outside both sides surfaces of the lift off resist in the track width direction, the pinned magnetic layer adjacent to the antiferromagnetic layer is etched outside both sides surfaces of the lift off resist in the track width direction, and the nonmagnetic conductive layer is partially etched outside both sides surfaces of the lift off resist in the track width direction to form the lead connecting portions. Therefore, the lead layers can be connected to the nonmagnetic conductive layer, thereby permitting manufacture of a spin valve thin film magnetic element in which the sensing current can be efficiently supplied to the laminate.

In the method of manufacturing a spin valve thin film magnetic element of the present invention, the laminate forming step preferably comprises etching the laminated film outside both side surfaces of the first lift off resist to leave a portion of the antiferromagnetic layer adjacent to the substrate.

In the method of manufacturing a spin valve thin film magnetic element, the laminated film is etched to leave a portion of the antiferromagnetic layer adjacent to the substrate, and thus the antiferromagnetic layer can be formed to protrude to both sides in the track width direction beyond the free magnetic layer and the pinned magnetic layer. Therefore, the height of the bias layers can be controlled to the same height as the layer position of the free magnetic layer, thereby permitting the application of a strong bias magnetic field to the free magnetic layer.

In the method of manufacturing a spin valve thin film magnetic element of the present invention, the bias layer forming step preferably comprises forming the bias layers and depositing sputtered particles in the direction at the angle θ₄ to laminate intermediate layers made of Ta or Cr on the bias layers, and the lead connecting portion forming step preferably comprises partially etching the intermediate layers at the same time as formation of the lead connecting portions.

In the method of manufacturing a spin valve thin film magnetic element, the intermediate layers are formed on the bias layers, and then partially etched during the formation of the lead connecting portions. Therefore, the intermediate layers can be located nearer to the substrate than at least the lead connecting portions, and thus only the lead layers can be connected to the lead connecting portions.

Also, since the bias layers are coated with the intermediate layers, the bias layers are not etched during the formation of the lead connecting portions, thereby preventing the probability that the bias layers are thinned to decrease the bias magnetic field.

In the method of manufacturing a spin valve thin film magnetic element of the present invention, preferably, the angle θ₄ is in the range of 50 to 85°, the angle θ₅ is in the range of 60 to 90°, and the angle θ₆ is in the range of 50 to 90°.

In the method of manufacturing a spin valve thin film magnetic element of the present invention, the widths of the pair of lead connecting portions in the track width direction are respectively defined by the relative distances between side positions of the laminate and the side positions of the second lift off resist.

In the method of manufacturing a spin valve thin film magnetic element, the widths of the pair of lead connecting portions in the track width direction can be respectively defined by the relative distances between side positions of the laminate and the side positions of the second lift off resist, and thus the dimension of each of the lead connecting portions in the track width direction can be precisely controlled. Therefore, the contact area of the lead layers in the lead connecting portions can be controlled so that the sensing current can be efficiently applied to the laminate.

In the method of manufacturing a spin valve thin film magnetic element of the present invention, the lead connecting portion forming step further comprises analyzing the sputtered particle type, which is discharged from the laminate during etching, by secondary ion mass spectroscopic analysis to detect the end point of etching.

In the method of manufacturing a spin valve thin film magnetic element, the end point of etching during the formation of the lead connecting portions is detected by analyzing the sputtered particle type by secondary ion mass spectroscopic analysis, and thus the precision of etching during the formation of the lead connecting portions can be improved to permit the formation of the lead connecting portions with high precision.

### BRIEF DESCRIPTION OF THE DRAWINGS

FIG. 1 is a schematic sectional view of a spin valve thin film magnetic element according to a first embodiment of the present invention;

FIG. 2 is a perspective view of a flying magnetic head comprising the spin valve thin film magnetic element shown in FIG. 1;

FIG. 3 is a schematic sectional view of a thin film magnetic head comprising the spin valve thin film magnetic element shown in FIG. 1;

FIG. 4 is a schematic drawing illustrating a micro track profile measuring method;

FIG. 5 is a drawing illustrating a laminated film forming step and a resist forming step in a method of manufacturing a spin valve thin film magnetic element of the present invention;

FIG. 6 is a drawing illustrating the laminate forming step in the method of manufacturing a spin valve thin film magnetic element of the present invention;

FIG. 7 is a drawing illustrating the bias layer forming step in the method of manufacturing a spin valve thin film magnetic element of the present invention;

FIG. 8 is a drawing illustrating the bias layer forming step in the method of manufacturing a spin valve thin film magnetic element of the present invention;

FIG. 9 is a drawing illustrating the lead connecting portion forming step in the method of manufacturing a spin valve thin film magnetic element of the present invention;

FIG. 10 is a drawing illustrating the lead layer forming step in the method of manufacturing a spin valve thin film magnetic element of the present invention;

FIG. 11 is a drawing illustrating the laminated film forming step and the first resist forming step in another method of manufacturing a spin valve thin film magnetic element of the present invention;

FIG. 12 is a drawing illustrating the laminate forming step in the other method of manufacturing a spin valve thin film magnetic element of the present invention;

FIG. 13 is a drawing illustrating the bias layer forming step in the other method of manufacturing a spin valve thin film magnetic element of the present invention;

FIG. 14 is a drawing illustrating the bias layer forming step in the other method of manufacturing a spin valve thin film magnetic element of the present invention;

FIG. 15 is a drawing illustrating the second resist forming step in the other method of manufacturing a spin valve thin film magnetic element of the present invention;

FIG. 16 is a drawing illustrating the lead connecting portion forming step in the other method of manufacturing a spin valve thin film magnetic element of the present invention;

FIG. 17 is a drawing illustrating the lead layer forming step in the other method of manufacturing a spin valve thin film magnetic element of the present invention;

FIG. 18 is a schematic sectional view of a spin valve thin film magnetic element according to a second embodiment of the present invention;

FIG. 19 is a schematic sectional view of a spin valve thin film magnetic element according to a third embodiment of the present invention;

FIG. 20 is a graph showing the measurement results of reproduced output by a micro track profile method with respect to a spin valve thin film magnetic element of an example;

FIG. 21 is a graph showing the measurement results of reproduced output by a micro track profile method with respect to a spin valve thin film magnetic element of a comparative example; and

FIG. 22 is a schematic sectional view of a conventional spin valve thin film magnetic element.

### DESCRIPTION OF THE PREFERRED EMBODIMENTS

Embodiments of the present invention will be described below with reference to the drawings.

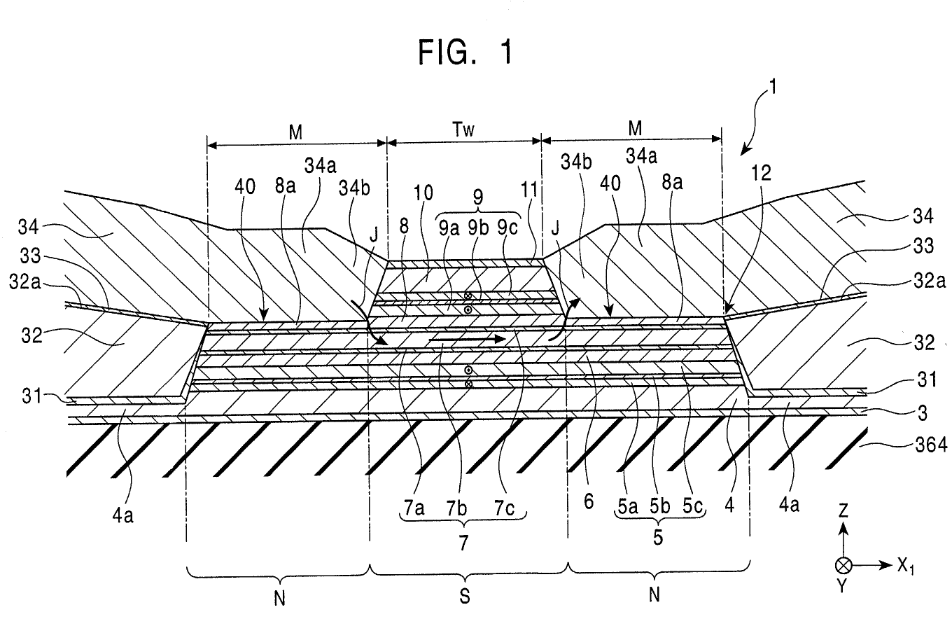

In FIGS. 1 to 19, the Z direction coincides with the movement direction of a magnetic recording medium, the Y direction coincides with the direction of a leakage magnetic field from the magnetic recording medium, and the X1 direction coincides with the track width direction of a spin valve thin film magnetic element.

### First Embodiment

FIG. 1 is a schematic sectional view showing a spin valve thin film magnetic element 1 according to a first embodiment of the present invention, as viewed from the magnetic recording medium side.

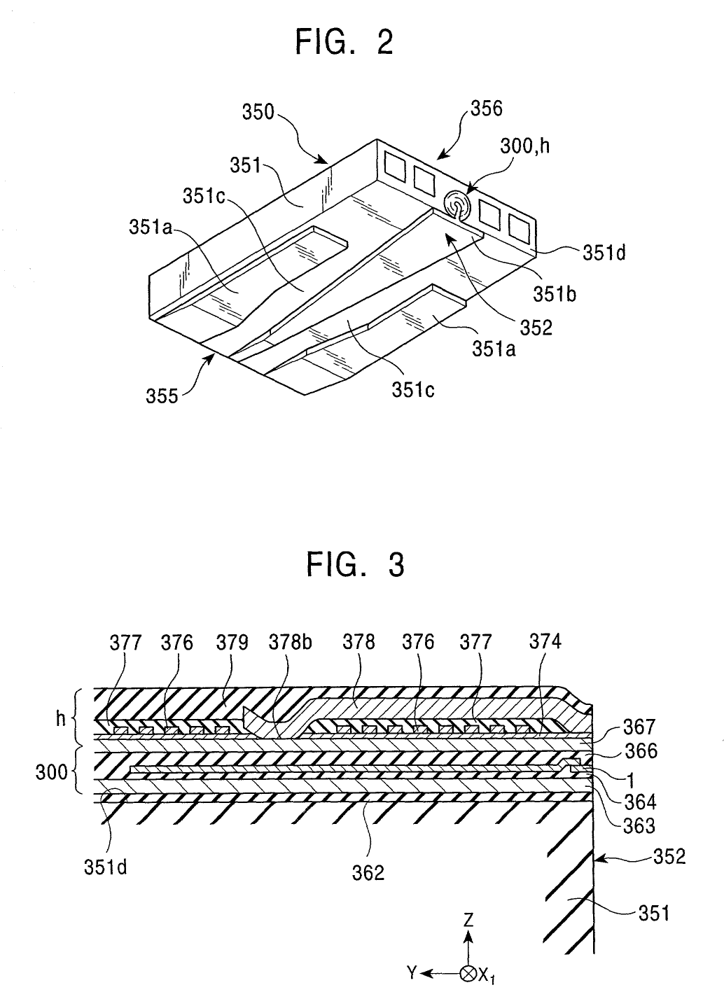

FIG. 2 shows a flying magnetic head 350 comprising a thin film magnetic head 300 comprising the spin valve thin film magnetic element 1, and FIG. 3 is a sectional view showing the principal portion of the thin film magnetic head 300.

The flying magnetic head 350 of the present invention shown in FIG. 2 mainly comprises a slider 351, and the thin film magnetic head 300 of the present invention, which is provided on the end surface 351d of the slider 351. Reference numeral 355 denotes the leading side on the upstream side in the movement direction of the magnetic recording medium, and reference numeral 356 denotes the trailing side. Also, rails 351a and 351b are formed on the medium-facing surface 352 of the slider 351, and air grooves 351c are formed between the respective rails.

Referring to FIG. 3, the thin film magnetic head 300 of the present invention is laminated on an insulating layer 362 formed on the end surface 351d of the slider 351, and comprises a lower shield layer 363 laminated on the insulating layer 362, a lower insulating layer 364 laminated on the lower shield layer 363, the spin valve thin film magnetic element 1 of the present invention, which is formed on the lower insulating layer 363 to be exposed at the medium-facing surface 352, an upper insulating layer 366 coated on the spin valve thin film magnetic element 1, and an upper shield layer 367 coated on the upper insulating layer 366.

The upper shield layer 367 is also used as a lower core layer of an inductive head h which will be described below.

The inductive head h comprises the lower core layer (upper shield layer) 367, a gap layer 374 laminated on the lower core layer 367, a coil 376, an upper insulating layer 377 coated on the coil 376, and an upper core layer 378 connected to the gap layer 374 and connected to the lower core layer 367 on the coil side.

The coil 376 is patterned to a spiral planar shape. The base end 378b of the upper core layer 378 is magnetically connected to the lower core layer 367 at substantially the center of the coil 376.

Furthermore, a core protecting layer 379 made of alumina is laminated on the upper core layer 378.

Referring to FIG. 1, the spin valve thin film magnetic element 1 of the present invention is a so-called dual spin valve thin film magnetic element in which a nonmagnetic conductive layer, a pinned magnetic layer and an antiferromagnetic layer are laminated on both sides of a free magnetic layer as the center in the thickness direction.

The dual spin valve thin film magnetic element comprises a pair of combinations of the three layers, i.e., the free magnetic layer/the nonmagnetic conductive layer/the pinned magnetic layer, and can thus be expected to produce a high rate of change in resistance to permit application to high-density recording, as compared with a single spin valve thin film magnetic element comprising a single combination of the three layers, i.e., the free magnetic layer/the nonmagnetic conductive layer/the pinned magnetic layer.

The spin valve thin film magnetic element 1 of the present invention mainly comprises an underlying layer 3 of Ta or the like and formed on the lower insulating layer 364 (substrate), a first antiferromagnetic layer 4, a first pinned magnetic layer 5, a first nonmagnetic conductive layer 6 made of Cu or the like, a free magnetic layer 7, a second nonmagnetic conductive layer (a nonmagnetic conductive layer having a narrow portion) 8 made of Cu or the like, a second pinned magnetic layer (narrow pinned magnetic layer) 9, a second antiferromagnetic layer (narrow antiferromagnetic layer) 10 and a protecting layer 11 made of Ta or the like, which are laminated in turn to form a laminate 12. The spin valve thin film magnetic element 1 further comprises a pair of bias layers 32 made of CoPt alloy or the like and formed on both sides of the laminate 12, for orienting the magnetization of the free magnetic layer 7, and a pair of lead layers 34 formed on the bias layers 32 and made of Cu, Au, Cr, Ta, W, Rh, or the like, for supplying the sensing current to the laminate 12.

The free magnetic layer 7 comprises a lamination of a first anti-diffusion layer 7a made of Co or the like, a ferromagnetic free layer 7b, and a second anti-diffusion layer 7c made of Co or the like. The first and second anti-diffusion layers 7a and 7c have the function to prevent mutual diffusion between the free layer 7 and the adjacent first and second nonmagnetic conductive layers 6 and 8, respectively, and increase the rate of change in resistance (ΔR/R).

Each of the first and second anti-diffusion layers 7a and 7c preferably has a thickness in the range of 0.3 to 1.0 nm, and the ferromagnetic layer 7b preferably has a thickness of 1 to 3 nm.

The magnetization direction of the free magnetic layer is oriented in the X1 direction shown in the drawing by a bias magnetic field from each of the bias layers 32. The free magnetic layer 7 is put into a single magnetic domain state, thereby decreasing Barkhausen noise of the spin valve thin film magnetic element 1.

The first pinned magnetic layer 5 comprises a lamination of a first ferromagnetic pinned layer 5a, a first nonmagnetic intermediate layer 5b and a second ferromagnetic pinned layer 5c. The thickness of the second ferromagnetic pinned layer 5c is larger than that of the first ferromagnetic pinned layer 5a.

The magnetization direction of the first ferromagnetic pinned layer 5a is pinned in the Y direction shown in the drawing by an exchange coupling magnetic field with the first antiferromagnetic layer 4. The magnetization direction of the second ferromagnetic pinned layer 5c is pinned in the direction opposite to the Y direction by antiferromagnetic coupling with the first ferromagnetic pinned layer 5a.

In this way, the magnetization directions of the first and second ferromagnetic pinned layers 5a and 5c are antiparallel to each other, and thus the magnetic moments of both layers are canceled by each other. However, the second ferromagnetic pinned layer 5c is thicker than the first ferromagnetic pinned layer 5a, and thus magnetization (magnetic moment) of the second ferromagnetic layer 5c slightly remains to pin the net magnetization direction of the whole first pinned magnetic layer 5 in the direction opposite to the Y direction.

The thickness of the second ferromagnetic pinned layer 5c may be smaller than that of the first ferromagnetic pinned layer 5a.

The second pinned magnetic layer 9 comprises a lamination of a third ferromagnetic pinned layer 9a, second nonmagnetic intermediate layer 9b and a fourth ferromagnetic pinned layer 9c. The thickness of the third ferromagnetic pinned layer 9a is larger than that of the fourth ferromagnetic pinned layer 9c.

The magnetization direction of the fourth ferromagnetic pinned layer 9c is pinned in the Y direction shown in the drawing by an exchange coupling magnetic field with the second antiferromagnetic layer 10. The magnetization direction of the third ferromagnetic pinned layer 9a is pinned in the direction opposite to the Y direction by antiferromagnetic coupling with the fourth ferromagnetic pinned layer 9c.

In this way, like the first pinned magnetic layer 5, the magnetic moments of the third and fourth ferromagnetic pinned layers 9a and 9c are canceled by each other. However, the third ferromagnetic pinned layer 9a is thicker than the fourth ferromagnetic pinned layer 9c, and thus magnetization (magnetic moment) of the third ferromagnetic layer 9a slightly remains to pin the net magnetization direction of the whole second pinned magnetic layer 9 in the direction opposite to the Y direction.

The thickness of the third ferromagnetic pinned layer 9a may be smaller than that of the fourth ferromagnetic pinned layer 9c.

In the first and second pinned magnetic layers 5 and 9, the first to fourth ferromagnetic pinned layers 5a, 5c, 9a and 9c are antiferromagnetically coupled with each other, and magnetization of each of the second and third ferromagnetic pinned layers 5c and 9c remains, thereby causing a synthetic ferrimagnetic pinned state.

Also, the magnetization direction of the free magnetic layer 7 crosses the net magnetization direction of the first and second pinned magnetic layers 5 and 9.

Each of the first to fourth ferromagnetic pinned layers 5a, 5c, 9a and 9c preferably comprises a NiFe alloy, Co, a CoNiFe alloy, a CoNi alloy, or the like, and more preferably Co. The first to fourth ferromagnetic pinned layers 5a, 5c, 9a and 9c are preferably made of the same material. Each of the first and second nonmagnetic intermediate layers 5b and 9b preferably comprises one of Ru, Rh, Ir, Cr, Re and Cu, or an alloy thereof, and more preferably Ru.

Each of the first and fourth ferromagnetic pined layers 5a and 9c preferably has a thickness in the range of 1 to 2 nm, and each of the second and third ferromagnetic pinned layers 5c and 9a preferably has a thickness in the range of 2 to 3 nm.

Each of the first and second nonmagnetic intermediate layers 5b and 9b preferably has a thickness in the range of 0.7 to 0.9 nm.

Each of the first and second pinned magnetic layers 5 and 9 comprises the two ferromagnetic layers (the first to fourth ferromagnetic pinned layers 5a, 4c, 9a and 9c). However, the construction is not limited to this, and each of the first and second pinned magnetic layers 5 and 9 may comprise at least two ferromagnetic layers. In this case, preferably, the nonmagnetic intermediate layer is inserted between these ferromagnetic layers, and the magnetization directions of the adjacent ferromagnetic layers are made antiparallel to each other to establish the ferrimagnetic pinned state as a whole.

In this way, the first and second pinned magnetic layers 5 and 9 are in the so-called synthetic ferrimagnetic pinned state, and thus the net magnetization directions of the first and second pinned magnetic layers 5 and 9 can be strongly pinned to stabilize the first and second pinned magnetic layers 5 and 9.

The first and second nonmagnetic conductive layers 6 and 8 decrease magnetic coupling between the free magnetic layer 7 and the first and second pinned magnetic layers 5 and 9, respectively, and the sensing current mainly flows through the first and second nonmagnetic conductive layers 6 and 8. Each of the first and second nonmagnetic conductive layers 6 and 8 is preferably made of a nonmagnetic material having conductivity, such as Cu, Cr, Au, Ag, or the like, and more preferably Cu.

Each of the first and second nonmagnetic conductive layers 6 and 8 preferably has a thickness in the range of 2 to 2.5 nm.

Each of the first and second antiferromagnetic layers 4 and 10 is preferably made of a PtMn alloy. The PtMn alloy has excellent corrosion resistance, a high blocking temperature and a high exchange coupling magnetic field, as compared with a NiMn alloy and FeMn alloy conventionally used for antiferromagnetic layers.

Each of the first and second antiferromagnetic layers 4 and 10 may be made of any one of XMn alloys and PtX′Mn alloys (wherein X represents one element selected from Pt, Pd, Ir, Rh, Ru, and Os, and X′ represents at least one element selected from Pd, Cr, Ru, Ni, Ir, Rh, Os, Au, Ag, Ne, Ar, Xe and Kr).

In the PtMn alloy and alloys represented by the formula XMn, the amount of Pt or X is preferably in the range of 37 to 63 atomic %, and more preferably in the range of 44 to 57 atomic %.

In the alloys represented by the formula PtX′Mn, the amount of X′ +Pt is preferably in the range of 37 to 63 atomic %, and more preferably in the range of 44 to 57 atomic %.

Each of the first and second antiferromagnetic layers 4 and 10 preferably has a thickness in the range of 8 to 11 nm.

By using an alloy having the above proper composition range for the first and second antiferromagnetic layers 4 and 10, the first and second antiferromagnetic layers 4 and 10 producing a high exchange coupling magnetic field can be obtained by heat treatment in a magnetic field. The magnetization directions of the first and second pinned magnetic layers 5 and 9 can be strongly pinned by the exchange coupling magnetic field. Particularly, the use of the PtMn alloy can produce the first and second antiferromagnetic layers 4 and 10 each having an exchange coupling magnetic field of over 6.4×10⁴ A/m, and a blocking temperature of as high as 653 K (380° C.) at which the exchange coupling magnetic field is lost.

The first antiferromagnetic layer 4 is formed to extend to both sides in the X direction shown in the drawing beyond the first pinned magnetic layer 5 and the free magnetic layer 7. The bias layers 32 and the lead layers 34 are laminated in turn on the extensions 4a of the first antiferromagnetic layer 4.

Furthermore, the bias underlying layers 31 made of Ta or Cr are laminated between the extensions 4a of the first antiferromagnetic layer 4 and the bias layers 32. For example, when the bias layers 32 are formed on the bias underlying layers 31 made of a nonmagnetic metal Cr having a body-centered cubic structure (bec structure), the coercive force and remanence ratio of the bias layers 32 can be increased to increase the bias magnetic field necessary for putting the free magnetic layer 7 in the single magnetic domain state.

Furthermore, the intermediate layers 33 made of Ta or Cr are laminated between the bias layers 32 and the lead layers 34. In use of Cr for the lead layers 34, the intermediate layers 33 made of Ta function as diffusion barriers in the subsequent thermal process for curing resist, thereby preventing deterioration in the magnetic properties of the bias layers 32. In use of Ta for the lead layers 34, the intermediate layers 33 made of Cr have the effect of facilitating the deposition of Ta crystal having a low-resistance body-centered cubic structure on Cr.

In the laminate 12, a pair of notches are formed on the side apart from the lower insulating layer 364 (the substrate) to be located at both ends of the laminate in the X1 direction shown in the drawing to form a pair of lead connecting portions 40.

The lead connecting portions 40 are formed on both sides of the second pinned magnetic layer 9, the second antiferromagnetic layer 10, and a portion of the second nonmagnetic conductive layer 8 in the X1 direction.

The second antiferromagnetic layer 10 and the second pinned magnetic layer 9) are narrower than the free magnetic layer 7 in the X1 direction (the track width direction).

The portion of the second nonmagnetic conductive layer 8, which is near the second pinned magnetic layer 9, is also narrower than the free magnetic layer 7.

The width of the portion of the second nonmagnetic conductive layer 8, which is near the free magnetic layer 7, is substantially equal to the free magnetic layer 7, thereby forming the extensions 8a extending in the X1 direction.

The overlay portions 34a of the lead layers 34 are connected to the lead connecting portions 40.

The lead layers 34 are formed on the bias layers 32 to extend from both sides of the laminate 12 in the X1 direction to the center thereof and to adhere to both ends of the laminate 12 in the X1 direction, the overlay portions 34a being connected to the lead connecting portions 40.

The overly portions 34a are arranged on the lead connecting portions 40 with a space Tw therebetween in the X1 direction shown in the drawing. The space Tw coincides with the optical track width of the spin valve thin film magnetic element 1.

Therefore, in the lead connecting portions 40, the extensions 8a of the second nonmagnetic conductive layers 8 extend in the X1 direction, and thus the overlay portions 34a are joined directly to the extensions 8a of the second nonmagnetic conductive layer 8 without the second antiferromagnetic layer 10 provided therebetween. The overlay portions 34a are separated from the free magnetic layer 7 by the extensions 8a.

The width M of each of the lead connecting portions 40 in the X1 direction (the track width direction) is preferably in the range of 0.03 to 0.5 μm. With the width M in this range, the contact area between the lead layers 34 and the laminate 12 in the lead connecting portions 40 can be increased to decrease bond resistance which does not contribute to the magnetoresistive effect. Therefore, the sensing current can be efficiently passed through the laminate 12 to improve the reproducing characteristics.

The lead connecting portions 40 respectively comprise notches so that the lead layers 34 are respectively fitted into the notches for connection, and thus the steps between the laminate 12 and the lead layers 34 can be decreased to decrease the gap width of the spin valve thin film magnetic element 1. When the upper insulating layer 366 is laminated on the spin valve thin film magnetic element 1, as shown in FIG. 3, there is no probability of producing pin holes or the like in the upper insulating layer 366, thereby increasing the insulation performance of the spin valve thin film magnetic element 1.

The pair of bias layers 32 comprising, for example, a CoPt (cobalt-platinum) alloy are formed on both sides of the laminate in the X1 direction, i.e., both sides in the track width direction. The bias layers 32 are adjacent to the free magnetic layer 7 at the same layer position as the free magnetic layer 7. The upper surfaces 32a of the bias layers 32 are joined to the laminate 12 at positions nearer to the lower insulating layer 364 (substrate) than the lead connecting portions 40. The material of the bias layers 32 is not limited to a hard magnetic material such as CoPt or the like, and an exchange coupling film (exchange bias film) comprising a laminate of an antiferromagnetic film and a ferromagnetic film may be used.

Also, the intermediate layers 33 are formed between the bias layers 32 and the lead layers 34. The intermediate layers 33 abut on both ends of the extensions 8a of the second nonmagnetic conductive layer 8 in the X1 direction.

Therefore, only the lead layers 34 are connected to the lead connecting portions 40.

In the spin valve thin film magnetic element 1, the sensing current J (arrow J) is mainly applied to the laminate 12 from the vicinities of the tips 34b of the overlay portions 34, as shown in FIG. 1.

Therefore, the sensing current is most liable to flow through the central portion of the laminate 12, which is not covered with the overlay portions 34a, and the sensing current is concentrated in this region, thereby substantially increasing the magnetoresistive (MR) effect to increase the sensitivity of a leakage magnetic field from the magnetic recording medium. Therefore, the region not covered with the overlay portions 34a is referred to as the “sensitive zone S”, as shown in FIG. 1.

On the other hand, in the regions covered with the overlay portions 34a, the sensing current is significantly decreased to substantially decrease the magnetoresistive (MR) effect, thereby decreasing sensitivity of a leakage magnetic field from the magnetic recording medium, as compared with the sensitive zone S. The regions covered with the overlay portions 34a are referred to as the “dead zones N”.

The portions (the overlay portions 34a) of the lead layers 34 are adhered to the lead connecting portions 40 located at both ends of the laminate 12 in the track width direction to form the portion (sensitive zone S) which substantially contributes to reproduction of a recording magnetic field from the magnetic recording medium, and the portions (dead zones N) which do not substantially contribute to reproduction of a recording magnetic field from the magnetic recording medium. The width of the sensitive zone S corresponds to the magnetic track width of the spin valve thin film magnetic element 1, thereby making it possible to comply with a narrower track.

Since the overlay portions 34a are joined directly to the extensions 8a of the second nonmagnetic conductive layer 8 made of Cu and having low resistivity without the second antiferromagnetic layer 10 with high resistivity provided therebetween, the component of the sensing current which flows into the laminate 12 through the lead connecting portions 40 can be increased to significantly decrease other shunt components.

Particularly, the shunt component, which flows to the portion of the laminate 12 nearer to the lower insulating layer 364 (substrate) than the second antiferromagnetic layer 10 from the lead layers 34 through the bias layers 32, is significantly decreased to decrease the sensing current flowing to the dead zones N.

Therefore, the sensing current can be concentrated in the sensitive zone S not covered with the lead layers 34 to improve a change in voltage of the sensitive zone S, thereby improving the output characteristics of the spin valve thin film magnetic element 1.

Also, the shunt component of the sensing current can be decreased to express substantially no magnetoresistive effect in the dead zones covered with the lead layers 34. Therefore, a leakage magnetic field from the recording track of the magnetic recording medium is not detected in the dead zones N, thereby preventing side reading of the spin valve thin film magnetic element 1.

The range of the sensitive zone S of the laminate 12 can be determined by the micro track profile method. Namely, the sensitive zone can be defined as a zone in which when the spin valve thin film magnetic element 1 is scanned on the micro track on which a single is recorded, the obtained output is 50% or more of the maximum reproduced output.

The dead zones N of the laminate 12 are located on both sides of the sensitive zone S, and can be defined as a zone in which the obtained output is 50% or less of the maximum output.

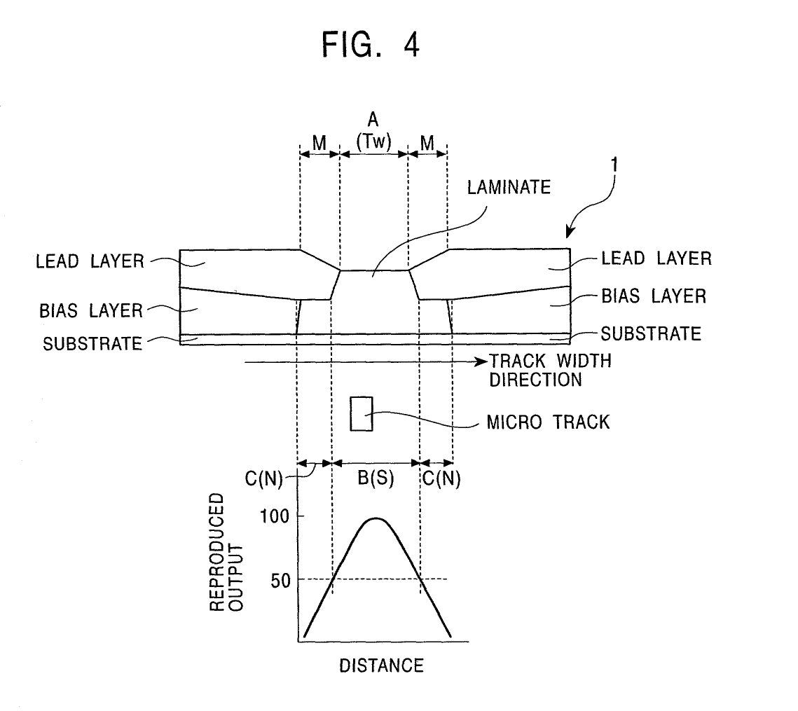

The micro track profile method will be described below with reference to FIG. 4.

Referring to FIG. 4, the spin valve thin film magnetic element 1 of the prevent invention, which comprises the laminate exhibiting the magnetoresistive effect, the bias layers formed on both sides of the laminate, and the lead layers formed on the bias layers to adhere to the laminate, is formed on a substrate.

Next, the width dimension A of the upper surface of the laminate which is not covered with the electrode layers is measured by an optical microscope or electron microscope. The width dimension A is defined as the track width Tw (referred to as the “optical track width Tw” hereinafter) measured by an optical method.

A predetermined signal is previously recorded as a micro track on the magnetic recording medium, and the spin valve thin film magnetic element 1 is scanned on the micro track in the track width direction to measure the relation between the width dimension A and reproduced output. Alternatively, the magnetic recording medium on which the micro track is formed may be scanned on the spin valve thin film magnetic element 1 in the track width direction to measure the relation between the width dimension A of the laminate and reproduced output. The results of measurement are shown on the lower side of FIG. 4.

The measurement results indicate that the reproduced output is high near the center of the laminate, and is low near the side ends of the laminate. It is thus found that in the vicinity of the center of the laminate, the magnetoresistive effect is sufficiently exhibited to cause contribution to the reproducing function, while in the vicinities of both ends thereof, the magnetoresistive effect deteriorates to decrease the reproduced output, decreasing the reproducing function.

In the present invention, the zone having a width dimension B and producing a reproduced output of 50% or more of the maximum reproduced output is defined as the sensitive zone S, and the zones each having a width dimension C and producing a reproduced output of 50% or less of the maximum reproduced output are defined as the dead zones N.

As shown in FIG. 4, the sensitive zone S substantially exhibits the magnetoresistive effect, and the width dimension B of the sensitive zone S corresponds to the magnetic track width.

As shown in FIG. 4, the track width (width dimension B) of the sensitive zone S is slightly larger than the optical track width Tw (dimension A). However, in consideration of the fact that the length of the whole laminate is about several tenths pm, the difference between the magnetic and optical track widths is very small, and thus both dimensions can be considered as substantially the same.

Next, the method of manufacturing the spin valve thin film magnetic element 1 will be described with reference to the drawings.

The manufacturing method comprises the laminated film forming step of forming a laminated film, the resist forming step of forming lift off resist, the laminate forming step of forming a laminate having a substantially trapezoidal sectional shape, the bias layer forming step of forming bias layers, the lead connecting portion forming step, and the lead layer forming step.

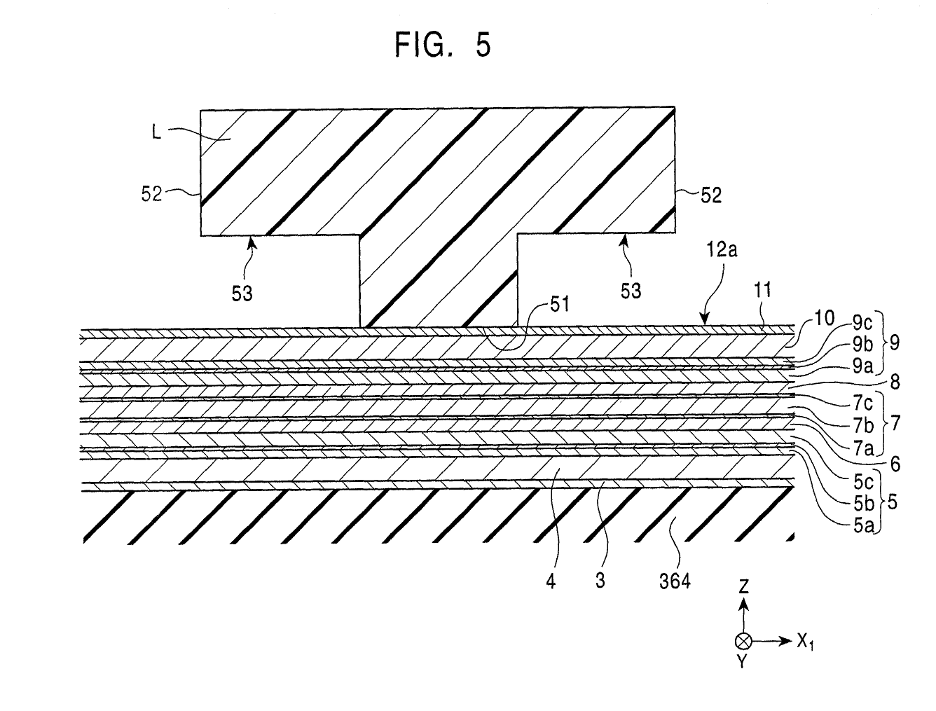

In the laminated film forming step, as shown in FIG. 5, the underlying layer 3, the first antiferromagnetic layer 4, the first ferromagnetic pinned layer 5a, the first nonmagnetic intermediate layer 5b, the second ferromagnetic pinned layer 5c, the first nonmagnetic conductive layer 6, the first anti-diffusion layer 7a, the ferromagnetic free layer 7b, the second anti-diffusion layer 7c, the second nonmagnetic conductive layer 8, the third ferromagnetic pinned layer 9a the second nonmagnetic intermediate layer 9b, the fourth ferromagnetic pinned layer 9c, the second antiferromagnetic layer 10 and the protecting layer 11 are laminated in turn on the lower insulating layer 364 (substrate) to form the laminated film 12a.

In the next resist forming step, as shown in FIG. 5, a lift off resist L is formed on the laminated film 12a. The lift off resist L comprises the butting surface 51 in contact with the laminated film 12a and the both side surfaces 52 holding the butting surface 51 therebetween, and a pair of notches 53 provided on both sides of the butting surface 51 in the track width direction to be located between the butting surface 51 and both side surfaces 52.

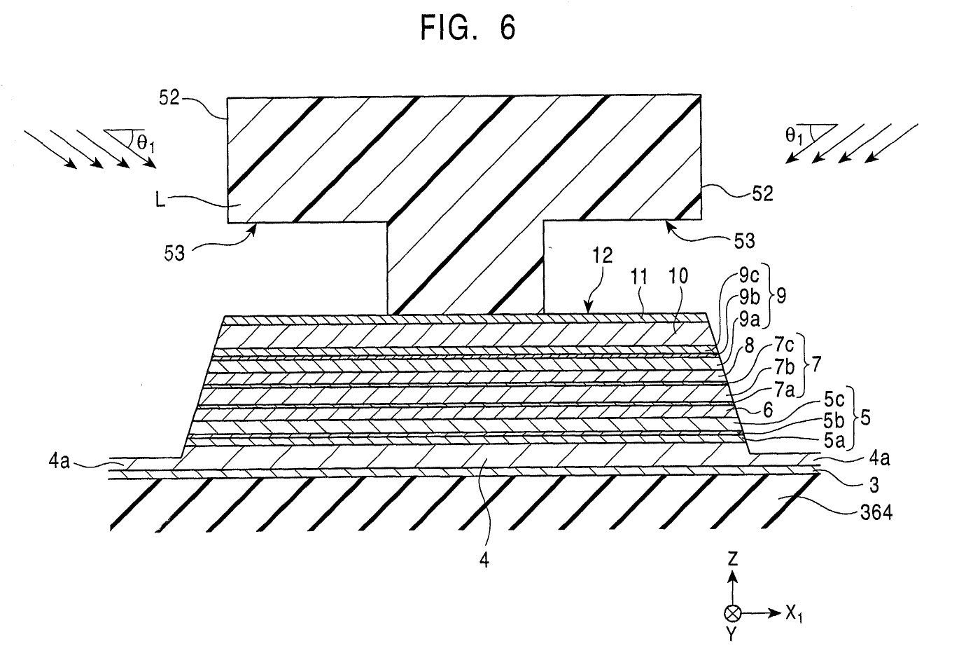

In the next laminate forming step, as shown in FIG. 6, the laminated film 12a is irradiated with an ion beam or the like (etching particle beam) of an inert gas element such as argon or the like in the direction at an angle θ₁ with the lower insulating layer 364 (substrate) to etch the portions of the laminated film 12a outside both side surfaces 52 of the lift off resist L in the X1 direction shown in the drawing (outside in the track width direction) until the first antiferromagnetic layer 4 is partially etched.

In this way, the laminate 12 having a substantially trapezoidal sectional shape is formed. The first antiferromagnetic layer 4 of the laminate 12 is partially etched to leave a portion, thereby forming the extensions 4a extending to both sides in the X1 direction.

Etching is preferably performed by ion milling with Ar, reactive ion etching (RIE) or the like. This method exhibits excellent linearity of the etching particle beam, and thus the etching particle beam can be applied in the specified direction.

The angle θ₁ which determines the irradiation direction of the etching particle beam such as an ion beam or the like is preferably in the range of 60 to 85°.

The angle θ₁ can be defined by, for example, controlling the angle between a grid of an ion gun and the lower insulating layer 364.

In this way, by applying the etching particle beam at the angle θ₁, anisotropic etching of the laminated film 12a can be performed to etch the portions of the laminated film 12a outside both side surfaces 52 of the lift off resist L, forming the laminate 12 having a substantially trapezoidal sectional shape.

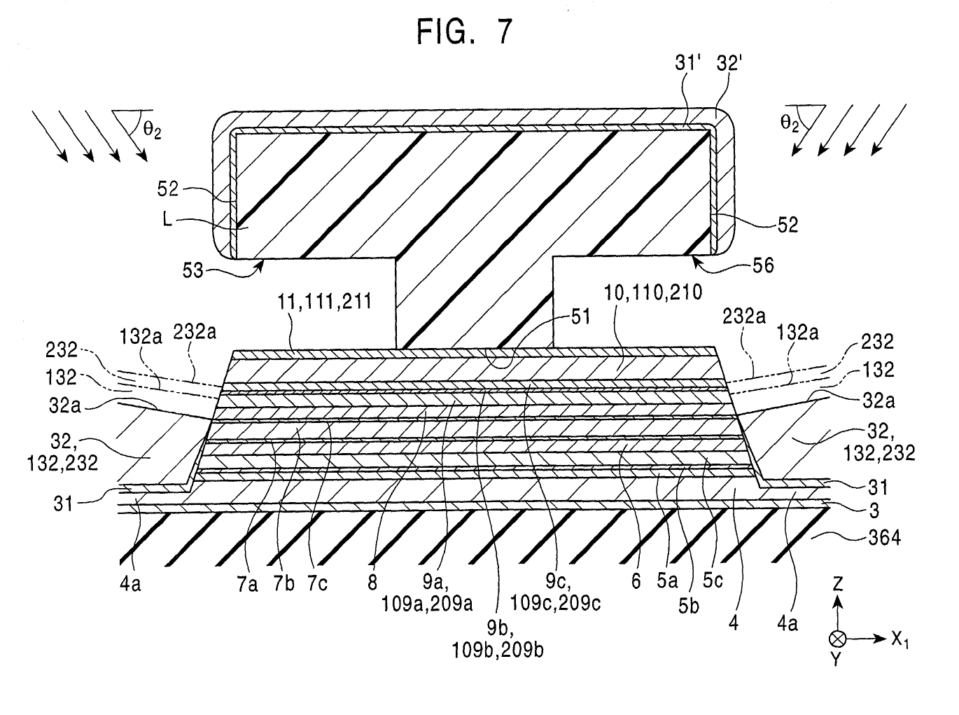

In the next bias layer forming step, as shown in FIG. 7, sputtered particles are deposited on both sides of the laminate 12 in the direction at an angle θ₂ (however, θ₂>θ₁) with the lower insulating layer 364 (substrate) to laminate the bias underlying layers 31 and the bias layers 32. The bias underlying layers 31 and the bias layers 32 are respectively laminated on the extensions 4a of the first antiferromagnetic layer 4 to be located on both sides of the laminate 12. The bias layers 32 are preferably laminated to the same layer position as at least the free magnetic layer 7. In FIG. 7, the bias layers 32 are laminated so that the upper surfaces 32a of the bias layers 32 are at the same position as the joint between the free magnetic layer 7 and the second nonmagnetic conductive layer 8.

In depositing the sputtered particles, the sputtered particles are also deposited on the lift off resist L to form layers 31′ and 32′ having the same compositions as the bias underlying layers 31 and the bias layers 32 on the lift off resist L.

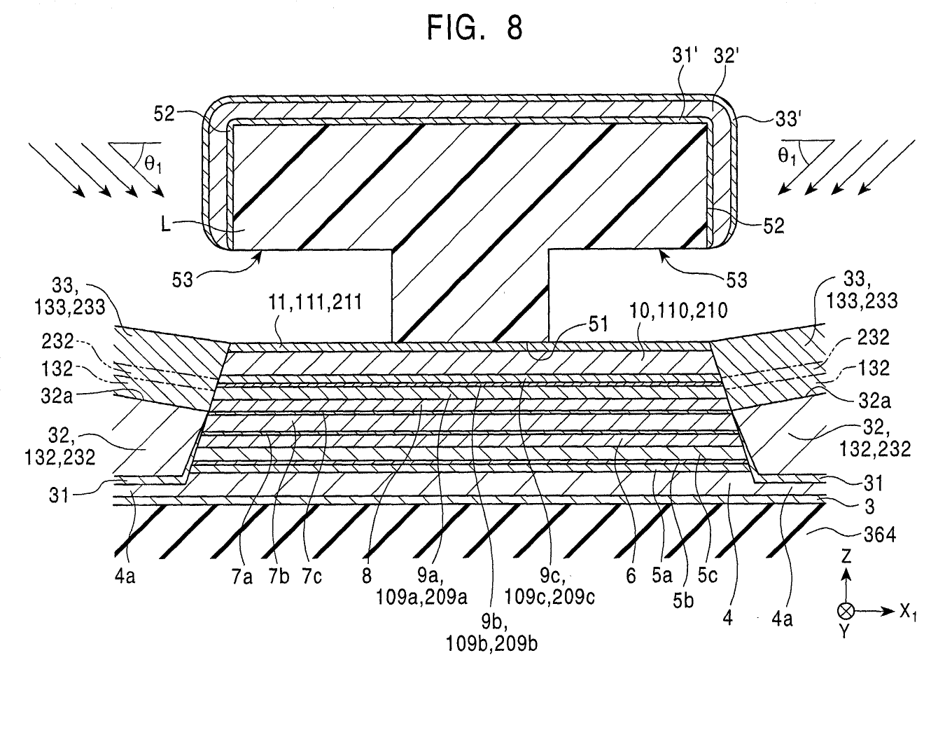

Next, as shown in FIG. 8, sputtered particles are deposited on the bias layers 32 in the direction at the angle θ₁ with the lower insulating layer 364 (substrate) to laminate the intermediate layers 33. The intermediate layers 33 are preferably laminated to the same layer position as the protecting layer 11. In FIG. 8, the upper surfaces of the intermediate layers 33 are at the same position as the upper surface of the protecting film 11.

In depositing the sputtered particles, the sputtered particles are also deposited on the lift off resist L to form a layer 33′ having the same composition as the intermediate layers 33 on the lift off resist L.

The sputtered particles are preferably deposited by any one of an ion beam sputtering process, a long slow sputtering process, and a collimation sputtering process, or a combination thereof. These methods exhibit excellent linearity of sputtered particles, and thus the sputtered particles can be applied in the specified direction.

The angle θ₂ is preferably in the range of 70 to 90°.

The angle θ₂ is preferably larger than the angle θ₁, i.e., the angle θ₂ can be preferably more obtuse than the angle θ₁ with respect to the lower insulating layer 364 (substrate).

The angles θ₁ and θ₂ can be defined by, for example, controlling the angle between the surface of the sputtering target and the lower insulating layer 364.

By depositing the sputtered particles in the direction at the angle θ₂, the bias underlying layers 31 and the bias layers 32 can be deposited only outside both side surfaces of the lift off resist L in the X1 direction. Also, the bias layers 32 can be formed at the same layer position as the free magnetic layer 7 without being overlaid on both ends of the laminate 12.

Since the intermediate layers 33 are formed by depositing the sputtered particles in the direction at the angle θ₁, the intermediate layers 33 can be formed to the same position as the upper surface of the protecting layer 11 of the laminate 12.

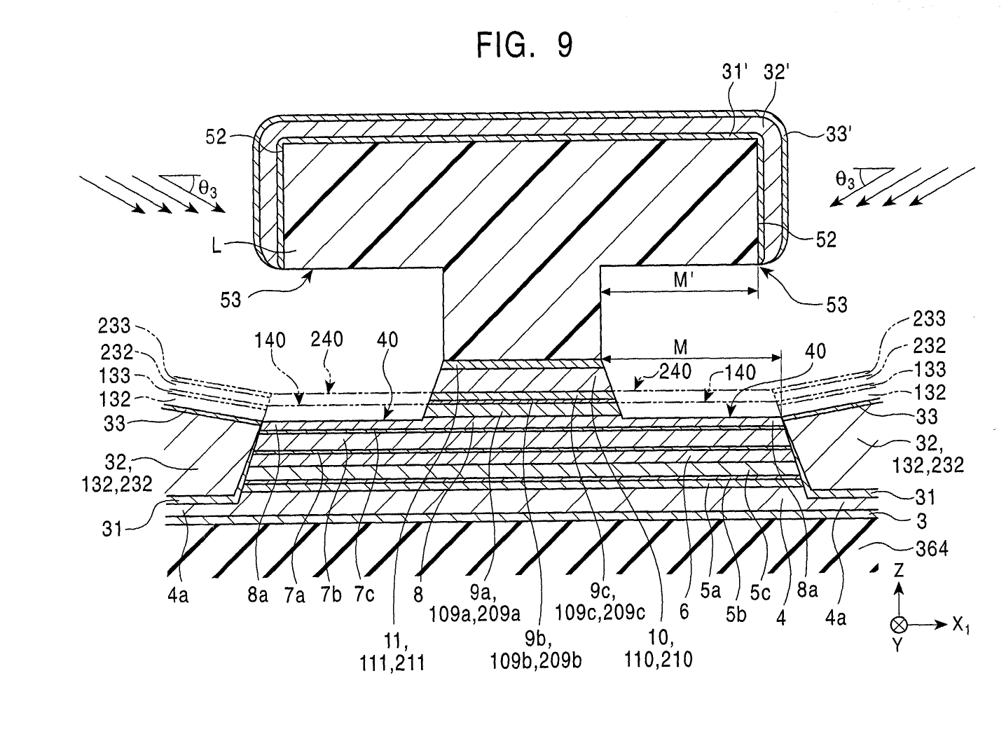

In the next lead connecting portion forming step, as shown in FIG. 9, an ion beam (etching particle beam) of an inert gas element of argon or the like is applied in the direction at an angle θ₃ (however, θ₂>θ₃) with the lower insulating layer 363 (substrate). As a result, the protecting layer 11, the second antiferromagnetic layer 10, the second pinned magnetic layer 9 and a portion of the second nonmagnetic conductive layer 8 are partially etched corresponding to the pair of notches 53 to form notches at both ends of the laminate in the X1 direction, forming the pair of lead connecting portions 40.

In this step, the second nonmagnetic conductive layer 8 is partially etched to form the extensions 8a extending to both sides in the track width direction.

At the same time, the intermediate layers 33 are also etched until the upper surfaces thereof are at the same layer position as the upper surfaces of the extensions 8a of the second nonmagnetic conductive layer 8.

Etching is preferably performed by ion milling with Ar, reactive ion etching (RIE), or the like. This method exhibits excellent linearity of the etching particle beam, and thus the etching particle beam can be applied in the specified direction.

The angle θ₃ which determines the irradiation direction of the etching particle beam such as an ion beam or the like is preferably in the range of 40 to 70°.

The angle θ₃ is preferably smaller than the angles θ₁ and θ₂, i.e., the angle θ₃ is preferably more acute than the angles θ₁ and θ₂ with respect to the lower insulating layer 364 (substrate).

The angle θ₃ can be defined by, for example, controlling the angle between a grid of an ion gun and the lower insulating layer 364.

In this way, by applying the sputtered particles at the angle θ₃ more acute than the angles θ₁ and θ₂, the sputtered particles can be applied to the portions of the laminate 12 corresponding to the notches 53 of the lift off resist L to provide notches in the laminate 12, forming the lead connecting portions 40.

The dimensions M of the lead connecting portions 40 in the X1 direction are respectively defined by the widths M'of the notches 53 of the lift off resist L in the X1 direction. In FIG. 8, the dimension M of each of the lead connecting portions 40 in the X1 direction is slightly larger than the width M′ of each of the notches 53 in the X1 direction. However, in consideration of the fact that the width of the whole laminate 12 is about several tenths Wm, the difference between both widths M and M′ is small, and thus the both widths can be considered as substantially the same. Therefore, the width M of each of the lead connecting portions 40 in the X1 direction can be defined by the width M′ of each of the notches 53 in the X1 direction, and thus the width dimension of each of the lead connecting portions 40 in the X1 direction can be precisely controlled. Therefore, the contact area of the lead layers 34 in the lead connecting portions 40 can be controlled so that the sensing current is efficiently applied to the laminate.

Furthermore, the sputtered particle type discharged from the laminate during etching is preferably analyzed by secondary ion mass spectroscopic analysis to detect the end point of etching.

For example, when the third ferromagnetic pinned layer 9a is made of a FeNi alloy, and the second nonmagnetic conductive layer Cu is made of Cu, during etching, the sputtered particles of Fe and Ni which constitute the third ferromagnetic pinned layer 9a are discharged, and then Cu which constitutes the second nonmagnetic conductive layer 8 is discharged. Therefore, etching is stopped a predetermined time after the detection of Cu by the secondary ion mass spectroscopic analysis so that the formation of the lead connecting portions 40 can be stopped when the second nonmagnetic conductive layer 8 is partially etched.

As a result, in forming the lead connecting portions 40, etching precision can be improved to permit the precise formation of the lead connecting portions 40.

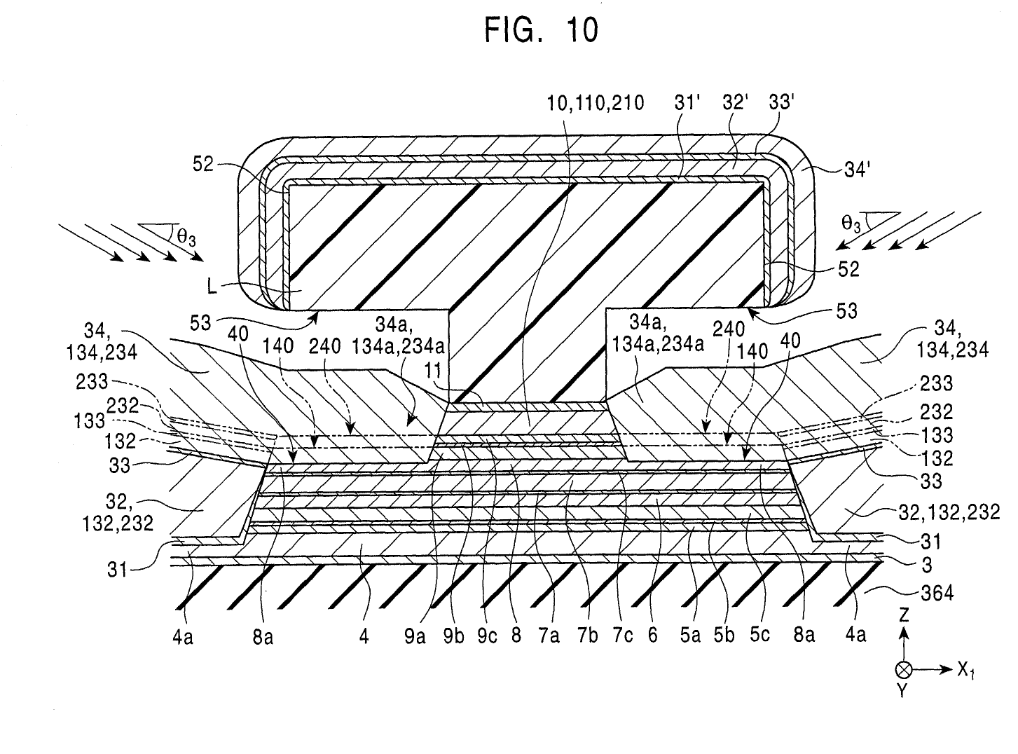

In the lead layer forming step, as shown in FIG. 10, other sputtered particles are deposited in the direction at an angle θ₃ with the lower insulating layer 364 (substrate) to laminate the lead layers 34.

The lead layers 34 are laminated on the intermediate layers 33 and the extensions 8a of the second nonmagnetic conductive layer 8. In this way, the lead layers 34 are formed to extend from both sides of the laminate 12 in the X1 direction to the center thereof, and to be connected to the lead connecting portions 40 of the laminate 12.

In deposition of the sputtered particles, the sputtered particles are also deposited on the lift off resist L to form a layer 34′ having the same composition as the lead layers 34 on the lift off resist L.

The sputtered particles are preferably deposited by any one of the ion beam sputtering process, the long slow sputtering process, and the collimation sputtering process, or a combination thereof. These methods exhibit excellent linearity of sputtered particles, and thus the sputtered particles can be applied in the specified direction.

The angle θ₃ which determines the irradiation direction of the sputtered particles is preferably substantially the same as the irradiation angle of the ion beam used in the lead connecting portion forming step.

The angles θ₃ can be defined by, for example, controlling the angle between the surface of the sputtering target and the lower insulating layer 364.

By depositing the sputtered particles in the direction at the angle θ₃, the lead layers 34 can be deposited on the lead connecting portions 40 corresponding to the notches 35 of the lift off resist L so that the overlay portions 34a of the lead layers 34 can be joined directly to the extensions 8a of the second nonmagnetic conductive layer 8.

Finally, the lift off resist L is removed, and then annealing is performed in a magnetic field to express an exchange coupling magnetic field in the first and second antiferromagnetic layers 4 and 10, pinning the magnetization directions of the first and second pinned magnetic layers 5 and 9. At the same time, a bias magnetic field is expressed in the bias layers 32 to orient the magnetization direction of the free magnetic layer 7 in the X1 direction, thereby obtaining the spin valve thin film magnetic element 1 shown in FIG. 1.

The method of manufacturing the spin valve thin film magnetic element 1 comprises applying the etching particle beam such as an ion beam or the like in the direction at the angle θ₁ to form the laminate 12 having a substantially trapezoidal sectional shape, and applying other sputtered particles in the direction at the angle θ₃ (θ₁>θ₃) to form the pair of the lead connecting portions 40 at the positions corresponding to the notches 35 of the lift off resist L. Therefore, the laminate 12 and the lead connecting portions 40 can be formed by using only one lift off resist, thereby shortening the process for manufacturing the spin valve thin film magnetic element 1.

Another method of manufacturing the spin valve thin film magnetic element 1 will be described with reference to the drawings.

The other manufacturing method is different from the above-described manufacturing method in the point that the laminate and the lead connecting portions are formed by using different lift off resists.

The other manufacturing method comprises the laminated film forming step of forming a laminated film, the first resist forming step of forming a first lift off resist, the laminate forming step of forming a laminate having a substantially trapezoidal sectional shape, the bias layer forming step of forming bias layers, the second resist forming step of forming a second lift off resist, the lead connecting portion forming step, and the lead layer forming step.

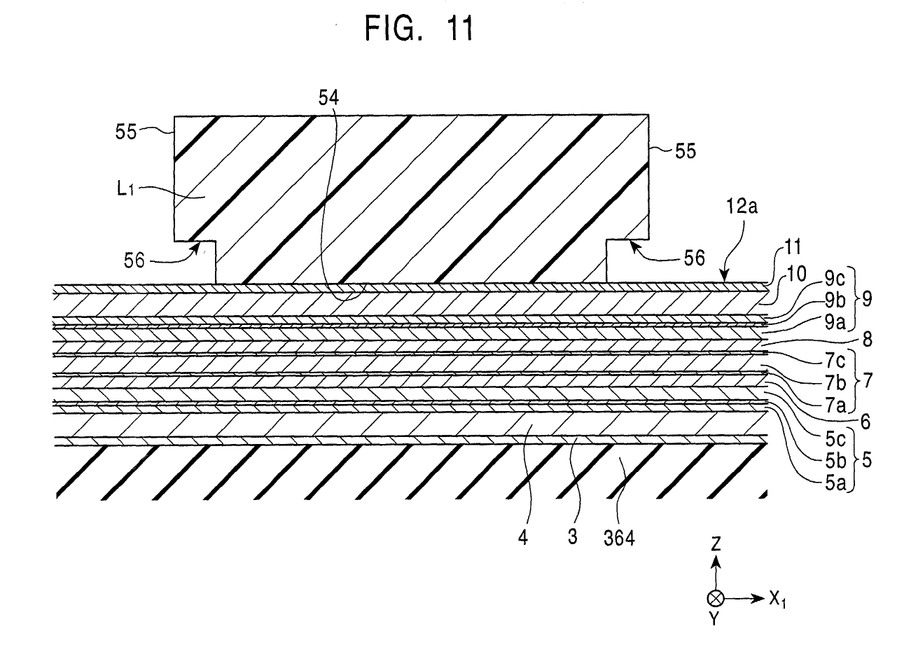

In the laminated film forming step, as shown in FIG. 11, the layers from the underlying layer 3 to the protecting layer 11 are laminated in turn to form the laminated film 12a by the same method as described above with reference to FIG. 5.

In the next first resist forming step, as shown in FIG. 11, a first lift off resist L1 is formed on the laminated film 12a. The first lift off resist L1 comprises a butting surface 54 in contact with the laminated film 12a and the both side surfaces 55 holding the butting surface 54 therebetween, and a pair of notches 56 provided on both sides of the butting surface 514 in the track width direction to be located between the butting surface 54 and both side surfaces 55.

The space between both side surfaces 55 in the X1 direction shown in the drawing is substantially the same as the space between both side surfaces 52 of the lift off resist L used in the above-described manufacturing method, and the width of the butting surface in the X1 direction is larger than the width of the butting surface 51 of the lift off resist L used in the above-described manufacturing method.

Therefore, the width of each of the notches 56 of the first lift off resist L1 is smaller than the width of each of the notches 53 of the lift off resist L used in the above-described manufacturing method.

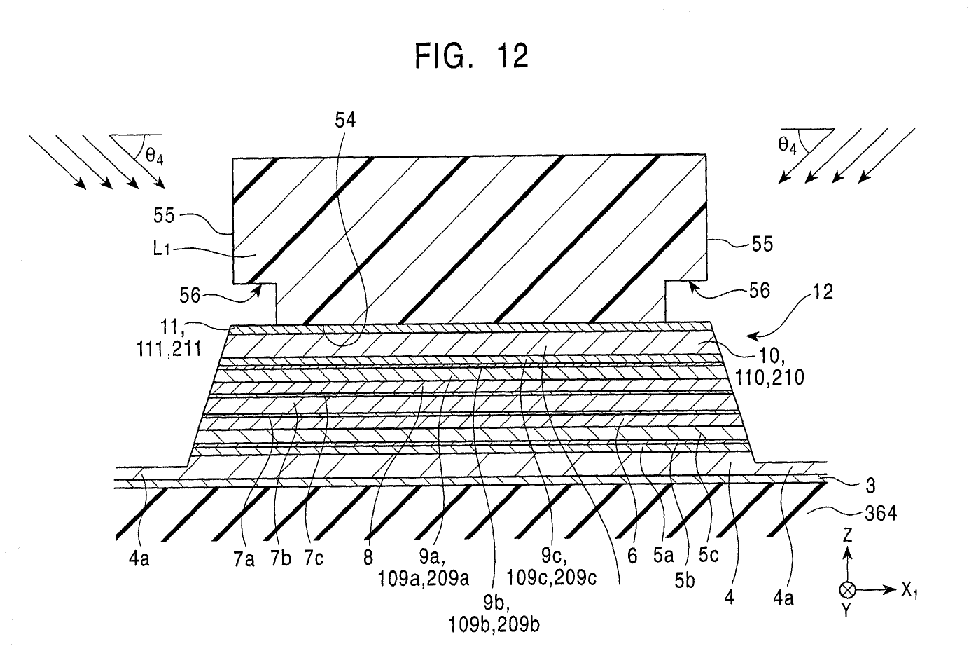

In the next laminate forming step, as shown in FIG. 12, the laminated film 12a is irradiated with an etching particle beam such as an ion beam or the like in the direction at an angle θ₄ with respect to the lower insulating layer 364 (substrate) to etch the laminated film 12a outside both side surfaces 55 of the first lift off resist L1 in the X1 direction shown in the drawing (outside in the track width direction) until the first antiferromagnetic layer 4 is partially etched.

In this way, the laminate 12 having a substantially trapezoidal sectional shape is formed. The first antiferromagnetic layer 4 of the laminate 12 is partially etched to leave a portion, thereby forming the extensions 4a extending to both sides in the X1 direction.

Etching is preferably performed by ion milling with Ar, reactive ion etching (RIE) or the like. This method exhibits excellent linearity of the etching particle beam, and thus the etching particle beam can be applied in the specified direction.

The angle θ₄ which determines the irradiation direction of the etching particle beam such as an ion beam or the like is preferably in the range of 50 to 85°.

The angle θ₄ can be defined by, for example, controlling the angle between a grid of an ion gun and the lower insulating layer 364.

In this way, by applying the etching particle beam at the angle θ₄, anisotropic etching of the laminated film 12a can be performed to etch the laminated film 12a outside both side surfaces 55 of the first lift off resist L1, forming the laminate 12 having a substantially trapezoidal sectional shape.

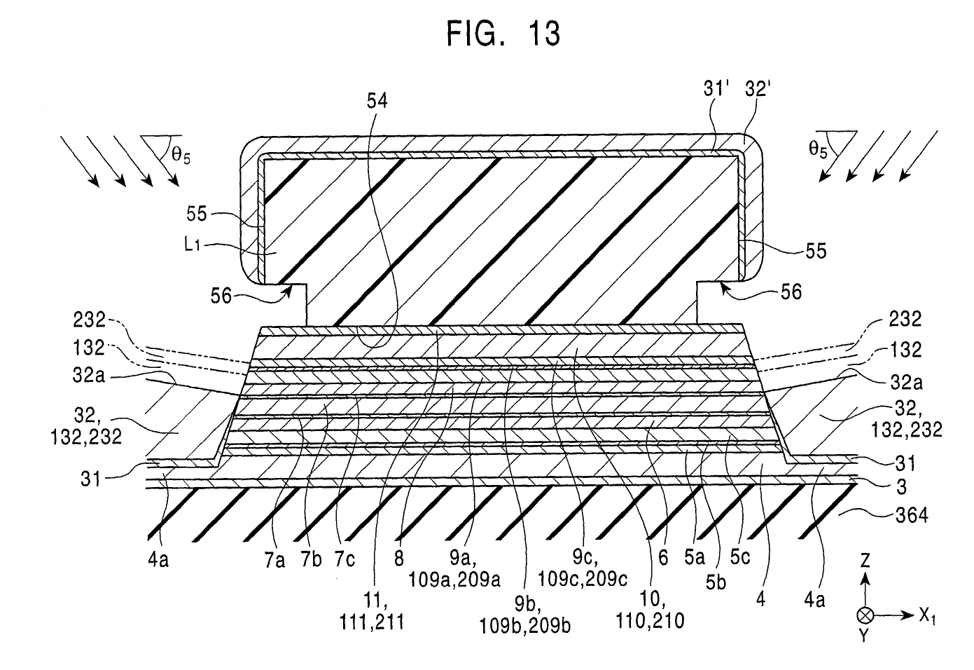

In the next bias layer forming step, as shown in FIG. 13, sputtered particles are deposited on both sides of the laminate 12 in the direction at an angle θ₅ (however, θ₅>θ₄) with the lower insulating layer 364 (substrate) to laminate the bias underlying layers 31 and the bias layers 32. The bias underlying layers 31 and the bias layers 32 are laminated on the extensions 4a of the first antiferromagnetic layer 4 on both sides of the laminate 12. The bias layers 32 are preferably laminated to the same layer position as at least the free magnetic layer 7. In FIG. 13, the bias layers 32 are laminated so that the upper surfaces 32a of the bias layers 32 are at the same position as the joint between the free magnetic layer 7 and the second nonmagnetic conductive layer 8.

In depositing the sputtered particles, the sputtered particles are also deposited on the first lift off resist L1 to form layers 31′ and 32′ having the same compositions as the bias underlying layers 31 and the bias layers 32 on the first lift off resist L1.

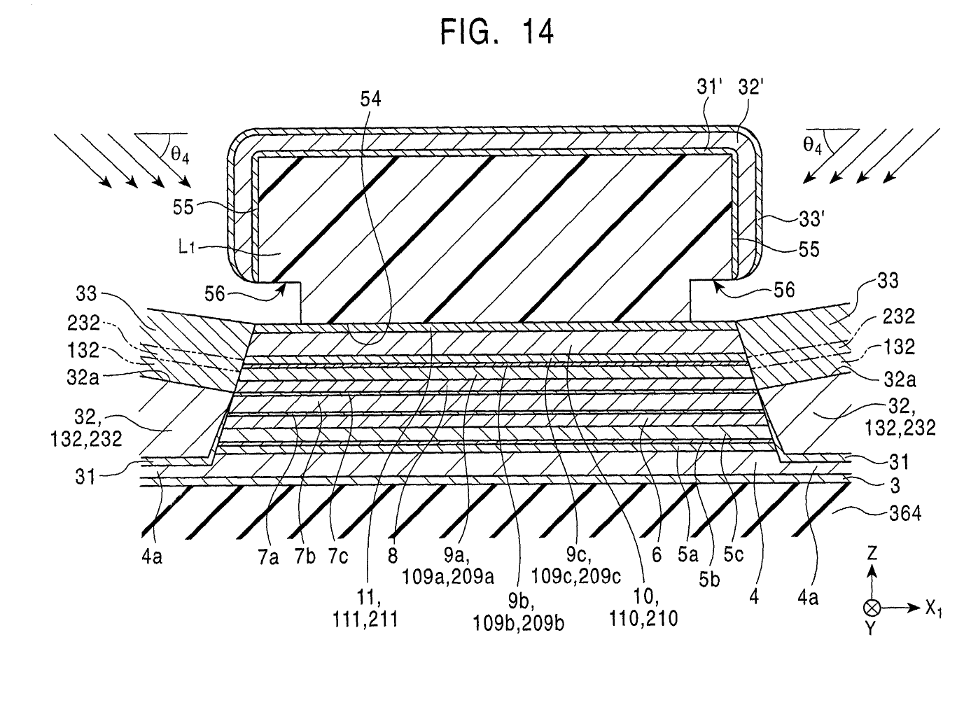

Next, as shown in FIG. 14, sputtered particles are deposited on the bias layers 32 in the direction at the angle θ₄ with the lower insulating layer 364 (substrate) to laminate the intermediate layers 33. The intermediate layers 33 are preferably laminated to the same layer position as the protecting layer 11. In FIG. 14, the upper surfaces of the intermediate layers 33 are at the same position as the upper surface of the protecting film 11.

In depositing the sputtered particles, the sputtered particles are also deposited on the first lift off resist L1 to form a layer 33′ having the same composition as the intermediate layers 33 on the first lift off resist L1.

The sputtered particles are preferably deposited by any one of the ion beam sputtering process, the long slow sputtering process, and the collimation sputtering process, or a combination thereof. These methods exhibit excellent linearity of sputtered particles, and thus the sputtered particles can be applied in the specified direction.

The angle θ₅ is preferably in the range of 60 to 90°.

The angle θ₅ is preferably larger than the angle θ₄, i.e., the angle θ₅ is preferably more obtuse than the angle θ₄ with respect to the lower insulating layer 364 (substrate).

The angles θ₄ and θ₅ can be defined by, for example, controlling the angle between the surface of the sputtering target and the lower insulating layer 364.

By depositing the sputtered particles in the direction at the angle θ₅, the bias underlying layers 31 and the bias layers 32 can be deposited only on the portions outside both side surfaces 55 of the first lift off resist L1 in the X1 direction. Also, the bias layers 32 can be formed at the same layer position as the free magnetic layer 7 without being overlaid on both ends of the laminate 12.

Since the intermediate layers 33 are formed by depositing the sputtered particles in the direction at the angle θ₄, the intermediate layers 33 can be formed to the same position as the upper surface of the protecting layer 11 of the laminate 12.

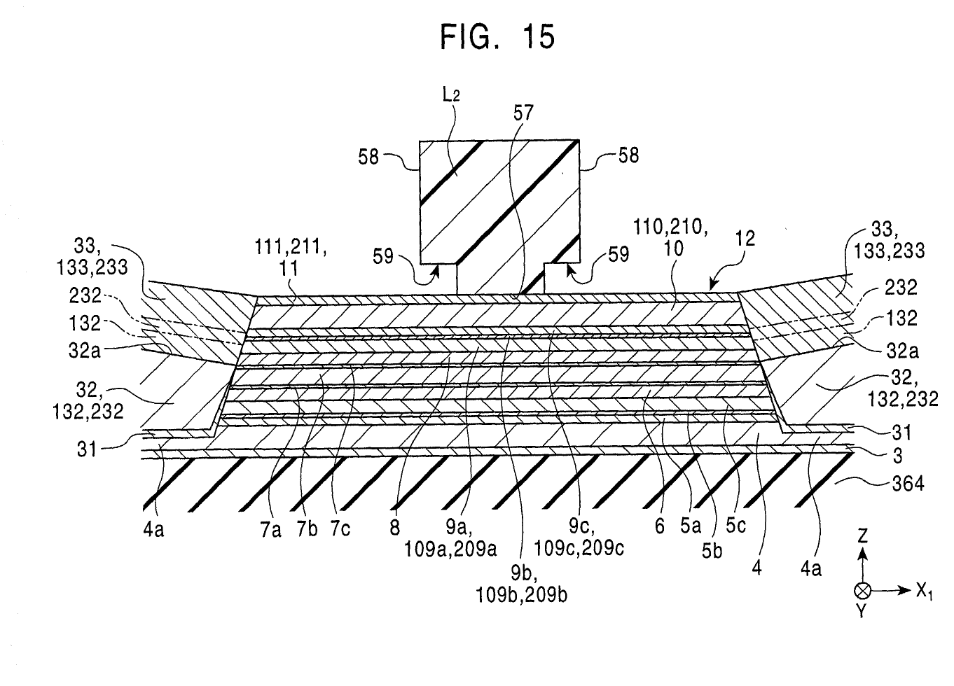

In the next second resist forming step, as shown in FIG. 15, the first lift off resist L1 is removed, and then a second lift off resist L2 is formed on the laminate 12. The second lift off resist L2 comprises a butting surface 57 in contact with the laminate 12, and both side surfaces 58 holding the butting surface 57 therebetween, and a pair of notches 59 provided on both sides of the butting surface 57 in the X1 direction to be located between the butting surface 57 and both side surfaces 58.

The width of the butting surface 57 in the X1 direction is smaller than the width of the butting surface 54 of the first lift off resist L1.

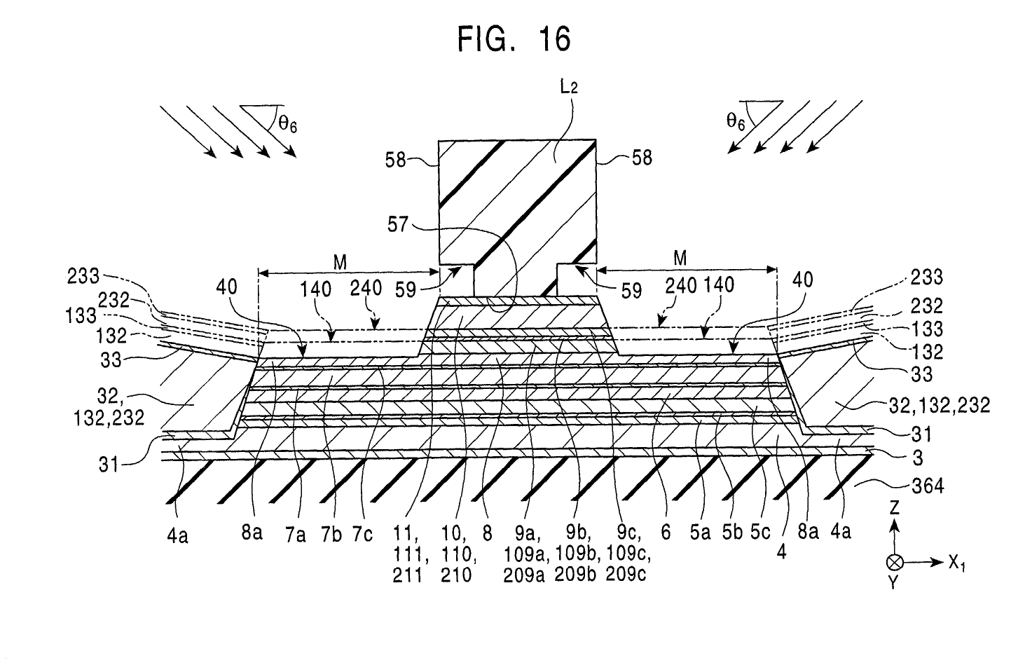

In the next lead connecting portion forming step, as shown in FIG. 16, other sputtered particles are applied in the direction at an angle θ₆ with the lower insulating layer 363 (substrate). As a result, the protecting layer 11, the second antiferromagnetic layer 10, the second pinned magnetic layer 9 and a portion of the second nonmagnetic conductive layer 8 are etched outside both side surfaces 58 of the second side surfaces 58 of the second lift off resist L2 to form notches at both ends of the laminate 12 in the X1 direction, forming the pair of lead connecting portions 40.

In this step, the second nonmagnetic conductive layer 8 is partially etched to form the extensions 8a extending to both sides in the track width direction.

At the same time, the intermediate layers 33 are also etched until the upper surfaces thereof are at the same layer position as the upper surfaces of the extensions 8a of the second nonmagnetic conductive layer 8.

Etching is preferably performed by ion milling with Ar, reactive ion etching (RIE), or the like. This method exhibits excellent linearity of the etching particle beam, and thus the etching particle beam can be applied in the specified direction.

The angle θ₆ which determines the irradiation direction of the etching particle beam is preferably in the range of 50 to 90°.

The angle θ₆ can be defined by, for example, controlling the angle between a grid of an ion gun and the lower insulating layer 364.

In this way, by applying the sputtered particles at the angle θ₆, anisotropic etching of the laminate 12 can be performed to form the notches at both ends of the laminate 12 outside both side surfaces 58 of the second lift off resist L2 in the X1 direction, thereby forming the lead connecting portions 40.

The dimensions M of the lead connecting portions 40 in the X1 direction are respectively defined by the relative distances between the side positions of the laminate 12 and the positions of the side surfaces 58 of the second lift off resist L2 in the X1 direction.

The side positions of the laminate 12 are determined by the positions of the side surfaces 55 of the first lift off resist L1 used in the laminate forming step. Therefore, the width M of the lead connecting portions 40 can be defined by respectively controlling the distances between both side surfaces of the first lift off resist L1 and both side surfaces of the second lift off resist L2. Thus, the width dimension of each of the lead connecting portions 40 in the X1 direction can be precisely controlled, and the contact area of the lead layers 34 in the lead connecting portions 40 can be controlled so that the sensing current can be efficiently applied to the laminate 12.

Furthermore, like in the above-described manufacturing method, the sputtered particle types discharged from the laminate 12 during etching are preferably analyzed by secondary ion mass spectroscopic analysis to detect the end point of etching.

For example, when the third ferromagnetic pinned layer 9a is made of a FeNi alloy, and the second nonmagnetic conductive layer 8 is made of Cu, during etching, the sputtered particles of Fe and Ni which constitute the third ferromagnetic pinned layer 9a are discharged, and then Cu which constitutes the second nonmagnetic conductive layer 8 is discharged. Therefore, etching is stopped a predetermined time after the detection of Cu by the secondary ion mass spectroscopic analysis so that the formation of the lead connecting portions 40 can be stopped when the second nonmagnetic conductive layer 8 is partially etched.

As a result, in forming the lead connecting portions 40, etching precision can be improved to permit the precise formation of the lead connecting portions 40.

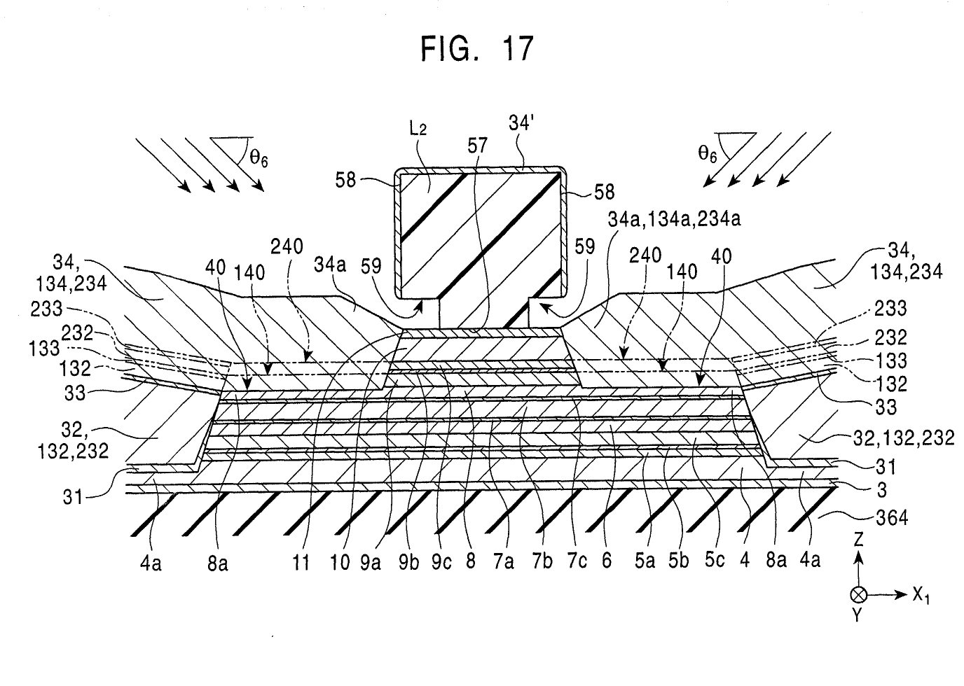

In the lead layer forming step, as shown in FIG. 17, other sputtered particles are deposited in the direction at an angle θ₆ with the lower insulating layer 364 (substrate) to laminate the lead layers 34.

The lead layers 34 are laminated on the intermediate layers 33 and the extensions 8a of the second nonmagnetic conductive layer 8. In this way, the lead layers 34 are formed to extend from both sides of the laminate 12 in the X1 direction to the center thereof, and to be connected to the lead connecting portions 40 of the laminate 12.

The sputtered particles are preferably deposited by any one of the ion beam sputtering process, the long slow sputtering process, and the collimation sputtering process, or a combination thereof. These methods exhibit excellent linearity of sputtered particles, and thus the sputtered particles can be applied in the specified direction.

The angle θ₆ which determines the irradiation direction of the sputtered particles is preferably substantially the same as the irradiation angle of the sputtered particles in the lead connecting portion forming step, but θ₆ may be different from that in the lead connecting portion forming step.

The angle θ₆ can be defined by, for example, controlling the angle between the surface of the sputtering target and the lower insulating layer 364.

By depositing the sputtered particles in the direction at the angle θ₆, the lead layers 34 can be deposited on the lead connecting portions 40 outside both side surfaces 58 of the second lift off resist L2 in the X1 direction so that the overlay portions 34a of the lead layers 34 can be joined directly to the extensions 8a of the second nonmagnetic conductive layer 8.

Finally, the second lift off resist L2 is removed, and then annealing is performed in a magnetic field to express an exchange coupling magnetic field in the first and second antiferromagnetic layers 4 and 10, pinning the magnetization directions of the first and second pinned magnetic layers 5 and 9. At the same time, a bias magnetic field is expressed in the bias layers 32 to orient the magnetization direction of the free magnetic layer 7 in the X1 direction, thereby obtaining the spin valve thin film magnetic element 1 shown in FIG. 1.

The other method of manufacturing the spin valve thin film magnetic element 1 comprises forming the laminate 12 having a substantially trapezoidal sectional shape by using the first lift off resist L1, and forming the lead connecting portions 40 by using the second lift off resist L2. Therefore, the width of the laminate in the track width direction, and the width of each of the lead connecting portions in the track width direction can be precisely controlled to facilitate the manufacture of the spin valve thin film magnetic element 1 having the low probability of producing side reading with a narrow track.

### Second Embodiment

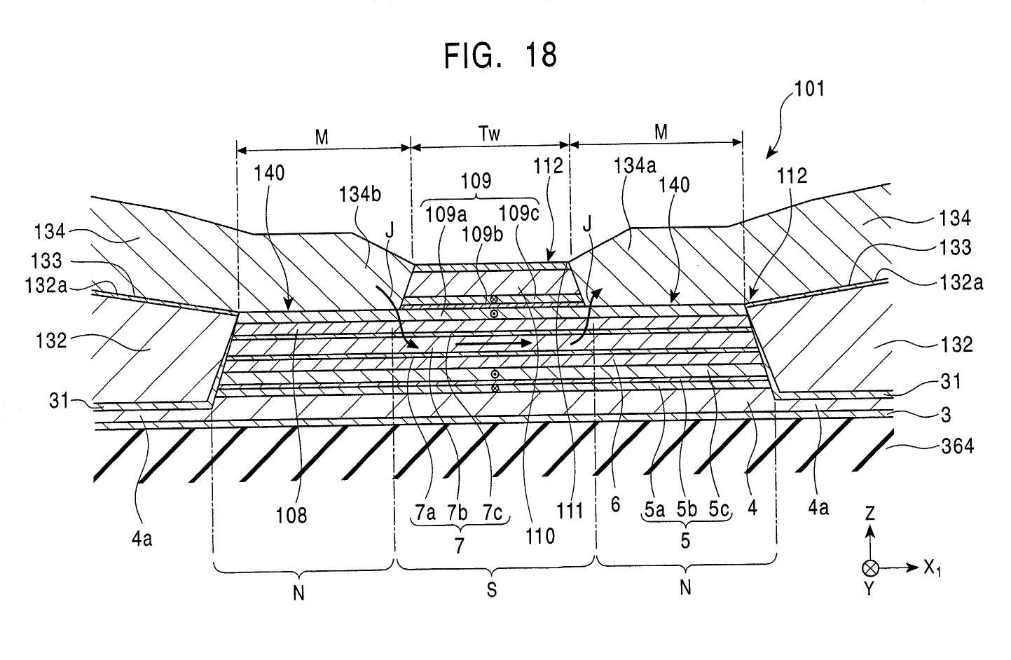

FIG. 18 is a schematic sectional view showing a spin valve thin film magnetic element 101 according to a second embodiment of the present invention, as viewed from the magnetic recording medium side.

Like the spin valve thin film magnetic element 1 of the first embodiment, the spin valve thin film magnetic element 101 shown in FIG. 18 constitutes a thin film magnetic head which constitutes a flying magnetic head together with an inductive head.

Like the spin valve thin film magnetic element 1 of the first embodiment, the spin valve thin film magnetic element 101 is a dual spin valve thin film magnetic element in which first and second nonmagnetic conductive layers 6 and 108, first and second pinned magnetic layers 5 and 109, and first and second antiferromagnetic layers 4 and 110 are laminated in turn on both sides of a free magnetic layer 7 in the thickness direction.

Namely, the spin valve thin film magnetic element 101 A comprises the first antiferromagnetic layer 4, the first pinned magnetic layer 5, the first nonmagnetic conductive layer 6, the free magnetic layer 7, the second nonmagnetic conductive layer 108, the second pinned magnetic layer 109 (including a narrow portion), the second antiferromagnetic layer 110 (the narrow antiferromagnetic layer) and a protecting layer 111, which are laminated in turn on the underlying layer 3 laminated on the lower insulating layer 364.

In this way, the layers from the underlying layer 3 to the protecting layer 111 are laminated in turn to form a laminate 112 having a substantially trapezoidal sectional shape.

The spin valve thin film magnetic element 101 further comprises a pair of bias layers 132 made of CoPt alloy or the like and formed on both sides of the laminate 112, for orienting the magnetization of the free magnetic layer 7, and a pair of lead layers 134 formed on the bias layers 132 and made of Cu, Au, Cr, Ta, W, Rh, or the like, for supplying the sensing current to the laminate 112.

The spin valve thin film magnetic element 101 of the second embodiment is different from the spin valve thin film magnetic element 1 of the first embodiment in the point that the protecting layer 111, the second antiferromagnetic layer 110, the fourth ferromagnetic pinned layer 109c and the second nonmagnetic intermediate layer 109b are etched at both ends thereof in the track width direction to form lead connecting portions 140 on both sides of these layers in the track width direction, and overlay portions 134a of lead layers 134 are connected to the lead connecting portions 140.

Therefore, the underlying layer 3, the first antiferromagnetic layer 4, the first pinned magnetic layer 5, the free magnetic layer 7 and the bias underlying layer 31 are the same as the underlying layer 3, the first antiferromagnetic layer 4, the first pinned magnetic layer 5, the free magnetic layer 7, and the bias underlying layers 31 of the first embodiment, and thus descriptions thereof are omitted.

The second pinned magnetic layer 109 comprises a lamination of a third ferromagnetic pinned layer 109a, a second nonmagnetic intermediate layer 109b and a fourth ferromagnetic pinned layer 109c. The thickness of the third ferromagnetic pinned layer 109a is larger than that of the fourth ferromagnetic pinned layer 109c.

Also, the width of each of the fourth ferromagnetic pinned layer 109c and the second nonmagnetic intermediate layer 109b in the X1 direction is smaller than the width of the third ferromagnetic pinned layer 109a.

Therefore, the second pinned magnetic layer 109 is partially narrower than the free magnetic layer 7.

The magnetization direction of the fourth ferromagnetic pinned layer 109c is pinned in the Y direction shown in the drawing by an exchange coupling magnetic field with the second antiferromagnetic layer 110. The magnetization direction of the third ferromagnetic pinned layer 109a is pinned in the direction opposite to the Y direction by antiferromagnetic coupling with the fourth ferromagnetic pinned layer 109c.

Although magnetic moments of the third and fourth ferromagnetic pinned layers 109a and 109c are canceled by each other, the third ferromagnetic pinned layer 109a is thicker than the fourth ferromagnetic pinned layer 109c, and thus magnetization (magnetic moment) of the third ferromagnetic layer 109a slightly remains to pin the net magnetization direction of the whole second pinned magnetic layer 109 in the direction opposite to the Y direction.

Therefore, in the pinned magnetic layer 109, the third and fourth ferromagnetic pinned layers 109a and 109c are antiferromagnetically coupled with each other to leave magnetization of the third ferromagnetic pinned layers 109a, thereby causing a synthetic ferrimagnetic pinned state.

Also, the magnetization direction of the free magnetic layer 7 crosses the net magnetization directions of the second pinned magnetic layer 109.

Each of the third and fourth ferromagnetic pinned layers 109a and 109c preferably comprises a NiFe alloy, Co, a CoNiFe alloy, a CoFe alloy, a CoNi alloy, or the like, and more preferably Co. The third and fourth ferromagnetic pinned layers 109a and 109c are preferably made of the same material. The second nonmagnetic intermediate layers 109b comprises one of Ru, Rh, Ir, Cr, Re and Cu, or an alloy thereof, and more preferably Ru.

The fourth ferromagnetic pined layers 109c preferably has a thickness in the range of 1 to 2 nm, and the third ferromagnetic pinned layer 109a preferably has a thickness in the range of 2 to 3 nm.

The second nonmagnetic intermediate layers 109b preferably has a thickness in the range of 0.7 to 0.9 nm.

The second pinned magnetic layer 109 comprises the two ferromagnetic layers (the third and fourth ferromagnetic pinned layers 109a and 109c). However, the construction is not limited to this, and each of the second pinned magnetic layer 109 may comprise at least two ferromagnetic layers. In this case, preferably, the nonmagnetic intermediate layer is inserted between these ferromagnetic layers, and the magnetization directions of the adjacent ferromagnetic layers are made antiparallel to each other to establish the ferrimagnetic pinned state as a whole.

In this way, the second pinned magnetic layer 109 is in the so-called synthetic ferrimagnetic pinned state, and thus the magnetization direction of the second pinned magnetic layer 109 can be strongly pinned to stabilize the second pinned magnetic layers 109.

The second nonmagnetic conductive layer 108 decrease magnetic coupling between the free magnetic layer 7 and the first and second pinned magnetic layers 5 and 109, and the sensing current mainly flows through the second nonmagnetic conductive layer 108. The second nonmagnetic conductive layer 108 is preferably made of a nonmagnetic material having conductivity, such as Cu, Cr, Au, Ag, or the like, and more preferably Cu.

The second antiferromagnetic layer 110 is preferably made of a PtMn alloy. The PtMn alloy has excellent corrosion resistance, a high blocking temperature and a high exchange coupling magnetic field, as compared with a NiMn alloy and FeMn alloy conventionally used for antiferromagnetic layers.

The second antiferromagnetic layer 110 may be made of any one of XMn alloys and PtX′Mn alloys (wherein X represents one element selected from Pt, Pd, Ir, Rh, Ru, and Os, and X′ represents at least one element selected from Pd, Cr, Ru, Ni, Ir, Rh, Os, Au, Ag, Ne, Ar, Xe and Kr).

The PtMn alloy and an alloy represented by the formula XMn have the same composition as the second antiferromagnetic layer 10 of the first embodiment.

By using an alloy having the above proper composition range for the second antiferromagnetic layer 110, the second antiferromagnetic layer 110 producing a high exchange coupling magnetic field can be obtained by heat treatment in a magnetic field. The magnetization direction of the second pinned magnetic layer 109 can be strongly pinned by the exchange coupling magnetic field. Particularly, the use of the PtMn alloy can produce the second antiferromagnetic layer 110 having an exchange coupling magnetic field of over 6.4×10⁴ A/m, and a blocking temperature of as high as 653 K (380° C.) at which the exchange coupling magnetic field is lost.

The first antiferromagnetic layer 4 is formed to extend to both sides in the X direction shown in the drawing beyond the first pinned magnetic layer 5 and the free magnetic layer 7. The bias layers 132 and the lead layers 134 are laminated in turn on the extensions 4a of the first antiferromagnetic layer 4.

Furthermore, the bias underlying layers 31 made of Ta or Cr are laminated between the extensions 4a of the first antiferromagnetic layer 4 and the bias layers 132. For example, when the bias layers 132 are formed on the bias underlying layers 31 made of a nonmagnetic metal Cr, the coercive force and remanence ratio of the bias layers 132 can be increased to increase the bias magnetic field necessary for putting the free magnetic layer 7 in the single magnetic domain state.

Furthermore, the intermediate layers 133 made of Ta or Cr are laminated between the bias layers 132 and the lead layers 134. In use of Cr for the lead layers 134, the intermediate layers 133 made of Ta function as diffusion barriers in the subsequent thermal process for curing resist, thereby preventing deterioration in the magnetic properties of the bias layers 132. In use of Ta for the lead layers 134, the intermediate layers 133 made of Cr have the effect of facilitating the deposition of Ta crystal having a low-resistance body-centered cubic structure on Cr.

In the laminate 12, a pair of notches are formed on the side apart from the lower insulating layer 364 (the substrate) to be located at both ends of the laminate in the direction shown in the drawing to form a pair of lead connecting portions 140.

The lead connecting portions 140 are formed on both sides of a portion of the second pinned magnetic layer 109 and the second antiferromagnetic layer 110 in the X1 direction.

The second antiferromagnetic layer 110 is narrower than the free magnetic layer 7 in the X1 direction (the track width direction), the lead connecting portions 140 are formed on both sides of the second antiferromagnetic layer 110 in the X1 direction.

The portion of the second nonmagnetic conductive layer 8, which is near the second pinned magnetic layer 9, is also narrower than the free magnetic layer 7.

The fourth ferromagnetic pinned layer 109c and the second nonmagnetic intermediate layer 109b of the second pinned magnetic layer 109 are narrower than the free magnetic layer 7 in the X1 direction (the track width direction). Therefore, a portion of the second pinned magnetic layer 109 is narrower than the free magnetic layer 7, and the lead connecting portions 140 are formed on both sides of the portion of the second pinned magnetic layer 109 in the X1 direction.

The overlay portions 134a of the lead layers 134 are respectively connected to the lead connecting portions 140.

The lead layers 134 are formed on the bias layers 132 to extend from both sides of the laminate 112 in the X1 direction to the center thereof and to adhere to both ends of the laminate 112 in the X1 direction, the overlay portions 134a being respectively connected to the lead connecting portions 140.

Therefore, in the lead connecting portions 140, the third ferromagnetic pinned layer 109a extends to both sides in the X1 direction, and thus the overlay portions 134a are joined directly to the third ferromagnetic pinned layer 109a without the second antiferromagnetic layer 110 provided therebetween.

The lead connecting portions 140 respectively comprise the notches so that the lead layers 134 are respectively fitted into the notches for connection, and thus the steps between the laminate 112 and the lead layers 134 can be decreased to decrease the gap width of the spin valve thin film magnetic element 101. When the upper insulating layer 366 is laminated on the spin valve thin film magnetic element 101, as shown in FIG. 3, there is no probability of producing pin holes or the like in the upper insulating layer 366, thereby increasing the insulation performance of the spin valve thin film magnetic element 101.

The width M of each of the lead connecting portions 140 in the X1 direction (the track width direction) is preferably in the range of 0.3 to 0.5 μm. With the width M in this range, the contact area between the lead layers 134 and the laminate 112 in the lead connecting portions 140 can be increased to decrease bond resistance which does not contribute to the magnetoresistive effect. Therefore, the sensing current can be efficiently passed through the laminate 112 to improve the reproducing characteristics.

The pair of bias layers 132 each comprising, for example, a CoPt (cobalt-platinum) alloy are formed on both sides of the laminate 112 in the X1 direction, i.e., on both sides in the track width direction. The bias layers 132 are adjacent to the free magnetic layer 7 at the same layer position as the free magnetic layer 7. The upper surfaces 132a of the bias layers 132 are joined to the laminate 112 at positions nearer to the lower insulating layer 364 (substrate) than the lead connecting portions 140. The material of the bias layers 132 is not limited to a hard magnetic material such as CoPt or the like, and an exchange coupling film (exchange bias film) comprising a laminate of an antiferromagnetic film and a ferromagnetic film may be used.

Also, the intermediate layers 133 are formed between the bias layers 132 and the lead layers 134. The intermediate layers 133 abut on both ends of the third ferromagnetic pinned layer 109a of the laminate 112 in the X1 direction.

Therefore, only the lead layers 134 are connected to the lead connecting portions 140.

In the spin valve thin film magnetic element 101, when a sensing current is supplied to the laminate 112 from the lead layers 134, and a leakage magnetic field is applied from the magnetic recording medium in the Y direction, the magnetization direction of the free magnetic layer 7 is changed from the X1 direction to the Y direction. The electric resistance value changes based on the relation between the change in the magnetization direction of the free magnetic layer 7 and the magnetization directions of the first and second pinned magnetic layers 5 and 109 (referred to as the “magnetoresistive (MR) effect”), so that the leakage magnetic field from the magnetic recording medium can be detected by a change in voltage based on the change in the electric resistance value.

In the spin valve thin film magnetic element 101, the sensing current J (arrow J) is mainly applied to the laminate 112 from the vicinities of the tips 134b of the overlay portions 134, as shown in FIG. 18.

Therefore, the sensing current is most liable to flow through the region of the laminate 112, which is not covered with the overlay portions 134a, and the sensing current is concentrated in this region, thereby substantially increasing the magnetoresistive (MR) effect to increase the sensitivity of the leakage magnetic field from the magnetic recording medium. Therefore, like in the first embodiment, the region not covered with the overlay portions 134a is referred to as the “sensitive zone S”.

On the other hand, in the regions covered with the overlay portions 134a, the sensing current is significantly decreased to substantially decrease the magnetoresistive (MR) effect, thereby decreasing sensitivity of the leakage magnetic field from the magnetic recording medium, as compared with the sensitive zone S. Like in the first embodiment, the regions covered with the overlay portions 134a are referred to as the “dead zones N”.

The portions (the overlay portions 134a) of the lead layers 134 are adhered to the lead connecting portions 140 located at both ends of the laminate 112 in the track width direction to form the portion (sensitive zone S) which substantially contributes to reproduction of a recording magnetic field from the magnetic recording medium, and the portions (dead zones N) which substantially do not contribute to reproduction of a recording magnetic field from the magnetic recording medium. The width of the sensitive zone S corresponds to the magnetic track width of the spin valve thin film magnetic element 101, thereby making it possible to comply with a narrower track.

Since the overlay portions 134a are joined directly to the third ferromagnetic pinned layer 109a having low resistivity without the second antiferromagnetic layer 110 with high resistivity provided therebetween, the component of the sensing current which flows to the laminate 112 through the lead connecting portions 140 can be increased to significantly decrease other shunt components.

Particularly, the shunt component, which flows to the portion of the laminate 112 nearer to the lower insulating layer 364 (substrate) than the second antiferromagnetic layer 110 from the lead layers 134 through the bias layers 132, is significantly decreased to decrease the sensing current flowing to the dead zones N. Therefore, the sensing current can be concentrated in the sensitive zone S not covered with the lead layers 134 to improve a change in voltage of the sensitive zone S, thereby improving the output characteristics of the spin valve thin film magnetic element 101.

Also, the shunt component of the sensing current can be decreased to express substantially no magnetoresistive effect in the dead zones covered with the lead layers 134. Therefore, the leakage magnetic field from the recording track of the magnetic recording medium is not detected in the dead zones N, thereby preventing side reading of the spin valve thin film magnetic element 101.

Like in the first embodiment, the ranges of the sensitive zone S and the dead zones N can be determined by the micro track profile method.

The method of manufacturing the spin valve thin film magnetic element 101 is the same as the spin valve thin film magnetic element 1 of the first embodiment except the bias layer forming step and the lead connecting portion forming step. Namely, in the bias layer forming step, the bias layers 132 are formed so that the upper surfaces 132a thereof are located at the junction between the free magnetic layer 7 and the second pinned magnetic layer 109. In the lead connecting portion forming step, irradiation with the etching particle beam is stopped when both side portions of the protecting layer 111, the second antiferromagnetic layer 110, the fourth ferromagnetic pinned layer 109c, and the second nonmagnetic intermediate layer 109b in the track width direction are etched.

Namely, in the bias layer forming step for the spin valve thin film magnetic element 101, the bias layers 132 are formed so that the upper surfaces 132a thereof are located at substantially the same layer position as the third ferromagnetic pinned layer 109a, as shown by one-dot chain lines in FIG. 7 or 13. Furthermore, the intermediate layers 133 are formed on the bias layers 132, as shown in FIG. 8 or 14.

In the lead connecting portion forming step, both side portions of the protecting layer 111, the second antiferromagnetic layer 110, the fourth ferromagnetic pinned layer 109c, and the second nonmagnetic intermediate layer 109b in the track width direction are etched to form the lead connecting portions 140 shown by one-dot chain lines in FIG. 9 or 16.

The other steps are performed in the same manner as the first embodiment to obtain the spin valve thin film magnetic element 101 show in FIG. 18.

### Third Embodiment

A third embodiment of the present invention is described with reference to the drawings.

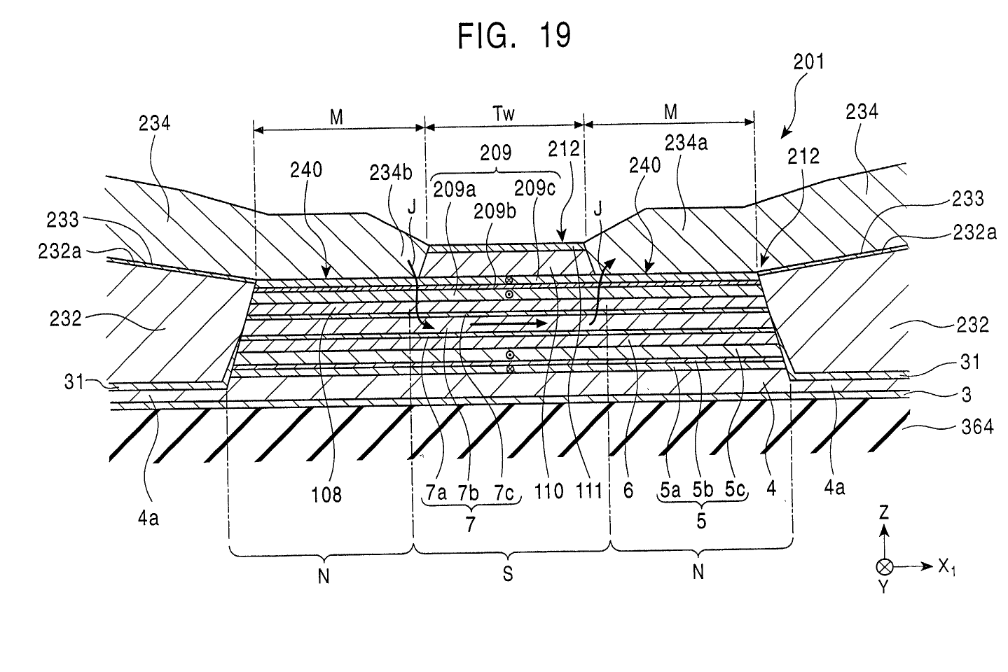

FIG. 19 is a schematic sectional view showing a spin valve thin film magnetic element 201 according to a third embodiment of the present invention, as viewed from the magnetic recording medium side.

Like the spin valve thin film magnetic element 1 of the first embodiment, the spin valve thin film magnetic element 201 shown in FIG. 19 constitutes a thin film magnetic head which constitutes a flying magnetic head together with an inductive head.

Like the spin valve thin film magnetic element 1 of the first embodiment, the spin valve thin film magnetic element 201 is a dual spin valve thin film magnetic element in which first and second nonmagnetic conductive layers 6 and 108, first and second pinned magnetic layers 5 and 209, and first and second antiferromagnetic layers 4 and 210 are laminated in turn on both sides of a free magnetic layer 7 in the thickness direction.

Namely, the spin valve thin film magnetic element 201 comprises the first antiferromagnetic layer 4, the first pinned magnetic layer 5, the first nonmagnetic conductive layer 6, the free magnetic layer 7, the second nonmagnetic conductive layer 108, the second pinned magnetic layer 209, the second antiferromagnetic layer 210 and a protecting layer 211, which are laminated in turn on the underlying layer 3 laminated on the lower insulating layer 364.

In this way, the layers from the underlying layer 3 to the protecting layer 211 are laminated in turn to form a laminate 212 having a substantially trapezoidal sectional shape.

The spin valve thin film magnetic element 201 further comprises a pair of bias layers 232 made of CoPt alloy or the like and formed on both sides of the laminate 212, for orienting the magnetization of the free magnetic layer 7, and a pair of lead layers 234 formed on the bias layers 232 and made of Cu, Au, Cr, Ta, W, Rh, or the like, for supplying the sensing current to the laminate 212.

The spin valve thin film magnetic element 201 of the third embodiment is different from the spin valve thin film magnetic element 1 of the first embodiment in the point that both side portions of the protecting layer 211 and the second antiferromagnetic layer 210 in the track width direction are etched to form lead connecting portions 240 on both sides of these layers in the track width direction, and overlay portions 234a of lead layers 234 are connected to the lead connecting portions 240.

Therefore, the underlying layer 3, the first antiferromagnetic layer 4, the first pinned magnetic layer 5, the free magnetic layer 7, the second nonmagnetic conductive layer 108, and the bias underlying layer 31 are the same as the underlying layer 3, the first antiferromagnetic layer 4, the first pinned magnetic layer 5, the free magnetic layer 7, the second nonmagnetic conductive layer 108, and the bias underlying layers 31 of the first and second embodiments, and thus descriptions thereof are omitted.

The second pinned magnetic layer 209 comprises a lamination of a third ferromagnetic pinned layer 209a, a second nonmagnetic intermediate layer 209b and a fourth ferromagnetic pinned layer 209c. The thickness of the third ferromagnetic pinned layer 209a is larger than that of the fourth ferromagnetic pinned layer 209c.

The magnetization direction of the fourth ferromagnetic pinned layer 209c is pinned in the Y direction shown in the drawing by an exchange coupling magnetic field with the second antiferromagnetic layer 210. The magnetization direction of the third ferromagnetic pinned layer 209a is pinned in the direction opposite to the Y direction by antiferromagnetic coupling with the fourth ferromagnetic pinned layer 209c.

Although magnetic moments of the third and fourth ferromagnetic pinned layers 209a and 209c are canceled by each other, the third ferromagnetic pinned layer 209a is thicker than the fourth ferromagnetic pinned layer 209c, and thus magnetization (magnetic moment) of the third ferromagnetic layer 209a slightly remains to pin the net magnetization direction of the whole second pinned magnetic layer 209 in the direction opposite to the Y direction.

The thickness of the third ferromagnetic pinned layer 209a may be smaller than that of the fourth ferromagnetic pinned layer 209c.

Therefore, in the pinned magnetic layer 209, the third and fourth ferromagnetic pinned layers 209a and 209c are antiferromagnetically coupled with each other to leave magnetization of the third ferromagnetic pinned layers 209a, thereby causing a synthetic ferrimagnetic pinned state.

Since the second pinned magnetic layer 209 is a layer exhibiting the so-called synthetic ferrimagnetic pinned state, the magnetization direction of the second pinned magnetic layer 209 can be strongly pinned to stabilize the second pinned magnetic layer 209.

The second antiferromagnetic layer 210 is preferably made of a PtMn alloy. The PtMn alloy has excellent corrosion resistance, a high blocking temperature and a high exchange coupling magnetic field, as compared with a NiMn alloy and FeMn alloy conventionally used for antiferromagnetic layers.

The second antiferromagnetic layer 210 may be made of any one of XMn alloys and PtX′Mn alloys (wherein X represents one element selected from Pt, Pd, Ir, Rh, Ru, and Os, and X′ represents at least one element selected from Pd, Cr, Ru, Ni, Ir, Rh, Os, Au, Ag, Ne, Ar, Xe and Kr).

The PtMn alloy and an alloy represented by the formula XMn have the same composition as the second antiferromagnetic layer 10 of the first embodiment.

By using an alloy having the above proper composition range for the second antiferromagnetic layer 210, the second antiferromagnetic layer 210 producing a high exchange coupling magnetic field can be obtained by heat treatment in a magnetic field. The magnetization direction of the second pinned magnetic layer 209 can be strongly pinned by the exchange coupling magnetic field. Particularly, the use of the PtMn alloy can produce the second antiferromagnetic layer 210 having an exchange coupling magnetic field of over 6.4×10⁴ A/m, and a blocking temperature of as high as 653 K (380° C.) at which the exchange coupling magnetic field is lost.

The first antiferromagnetic layer 4 is formed to extend to both sides in the X direction shown in the drawing beyond the first pinned magnetic layer 5 and the free magnetic layer 7. The bias layers 232 and the lead layers 234 are laminated in turn on the extensions 4a of the first antiferromagnetic layer 4.

Furthermore, the bias underlying layers 31 made of Ta or Cr are laminated between the extensions 4a of the first antiferromagnetic layer 4 and the bias layers 232.

Furthermore, the intermediate layers 233 made of Ta or Cr are laminated between the bias layers 232 and the lead layers 234. In use of Cr for the lead layers 234, the intermediate layers 233 made of Ta function as diffusion barriers in the subsequent thermal process for curing resist, thereby preventing deterioration in the magnetic properties of the bias layers 232. In use of Ta for the lead layers 234, the intermediate layers 233 made of Cr have the effect of facilitating the deposition of Ta crystal having a low-resistance body-centered cubic structure on Cr.

In the laminate 212, a pair of notches are formed on the side apart from the lower insulating layer 364 (the substrate) to be located at both ends of the laminate in the X1 direction shown in the drawing to form a pair of lead connecting portions 240.

The lead connecting portions 240 are formed on both sides of the second antiferromagnetic layer 210 in the X1 direction.

The second antiferromagnetic layer 210 is narrower than the free magnetic layer 7 in the X1 direction (the track width direction), and the lead connecting portions 240 are formed on both sides of the second antiferromagnetic layer 210 in the X1 direction.

The overlay portions 234a of the lead layers 234 are respectively connected to the lead connecting portions 240.

The lead layers 234 are formed on the bias layers 232 to extend from both sides of the laminate 212 in the X1 direction to the center thereof and to adhere to both ends of the laminate 212 in the X1 direction, the overlay portions 234a being respectively connected to the lead connecting portions 240. The lead layers 234 are separated with a space Tw therebetween in the X1 direction, the space Tw corresponding to the optical track width of the spin valve thin film magnetic element 201.

Therefore, in the lead connecting portions 240, the fourth ferromagnetic pinned layer 209c extends to both sides in the X1 direction, and thus the overlay portions 234a are joined directly to the fourth ferromagnetic pinned layer 209c without the second antiferromagnetic layer 210 provided therebetween.

The lead connecting portions 240 respectively comprise the notches so that the lead layers 234 are respectively fitted into the notches for connection, and thus the steps between the laminate 212 and the lead layers 234 can be decreased to decrease the gap width of the spin valve thin film magnetic element 201. When the upper insulating layer 366 is laminated on the spin valve thin film magnetic element 201, as shown in FIG. 3, there is no probability of producing pin holes or the like in the upper insulating layer 366, thereby increasing the insulation performance of the spin valve thin film magnetic element 2θ₁.

The width M of each of the lead connecting portions 240 in the X1 direction (the track width direction) is preferably in the range of 0.03 to 0.5 μm. With the width M in this range, the contact area between the lead layers 234 and the laminate 212 in the lead connecting portions 240 can be increased to decrease bond resistance which does not contribute to the magnetoresistive effect. Therefore, the sensing current can be efficiently passed through the laminate 212 to improve the reproducing characteristics.

The pair of bias layers 232 comprising, for example, a CoPt (cobalt-platinum) alloy are formed on both sides of the laminate 212 in the X1 direction, i.e., on both sides in the track width direction. The bias layers 232 are adjacent to the free magnetic layer 7 at the same layer position as the free magnetic layer 7. The upper surfaces 232a of the bias layers 232 are joined to the laminate 212 at positions nearer to the lower insulating layer 364 (substrate) than the lead connecting portions 240.

Also, the intermediate layers 233 are formed between the bias layers 232 and the lead layers 234. The intermediate layers 233 abut on both ends of the fourth ferromagnetic pinned layer 209c of the laminate 212 in the X1 direction.

Therefore, only the lead layers 234 are connected to the lead connecting portions 240.

In the spin valve thin film magnetic element 201, when a sensing current is supplied to the laminate 212 from the lead layers 234, and a leakage magnetic field is applied from the magnetic recording medium in the Y direction, the magnetization direction of the free magnetic layer 7 is changed from the X1 direction to the Y direction. The electric resistance value changes based on the relation between the change in the magnetization direction of the free magnetic layer 7 and the magnetization directions of the first and second pinned magnetic layers 5 and 209 (referred to as the “magnetoresistive (MR) effect”), so that the leakage magnetic field from the magnetic recording medium can be detected by a change in voltage based on the change in the electric resistance value.

In the spin valve thin film magnetic element 201, the sensing current J (arrow J) is mainly applied to the laminate 212 from the vicinities of the tips 234b of the overlay portions 234, as shown in FIG. 19.

Therefore, the sensing current is most liable to flow through the region of the laminate 212, which is not covered with the overlay portions 234a, and the sensing current is concentrated in this region, thereby substantially increasing the magnetoresistive (MR) effect to increase the sensitivity of the leakage magnetic field from the magnetic recording medium. Therefore, like in the first embodiment, the region not covered with the overlay portions 234a is referred to as the “sensitive zone S”.

On the other hand, in the regions covered with the overlay portions 234a, the sensing current is significantly decreased to substantially decrease the magnetoresistive (MR) effect, thereby decreasing sensitivity of the leakage magnetic field from the magnetic recording medium, as compared with the sensitive zone S. Like in the first embodiment, the regions covered with the overlay portions 234a are referred to as the “dead zones N”.

The portions (the overlay portions 234a) of the lead layers 234 are adhered to the lead connecting portions 240 located at both ends of the laminate 212 in the track width direction to form the portion (sensitive zone S) which substantially contributes to reproduction of a recording magnetic field from the magnetic recording medium, and the portions (dead zones N) which substantially do not contribute to reproduction of a recording magnetic field from the magnetic recording medium. The width of the sensitive zone S corresponds to the magnetic track width of the spin valve thin film magnetic element 201 , thereby making it possible to comply with a narrower track.

Since the overlay portions 234a are joined directly to the fourth ferromagnetic pinned layer 209c having low resistivity without the second antiferromagnetic layer 210 with high resistivity provided therebetween, the component of the sensing current which flows to the laminate 212 through the lead connecting portions 240 can be increased to significantly decrease other shunt components.

Particularly, the shunt component, which flows to the portion of the laminate 212 nearer to the lower insulating layer 364 (substrate) than the second antiferromagnetic layer 210 from the lead layers 234 through the bias layers 232, is significantly decreased to decrease the sensing current flowing to the dead zones N. Therefore, the sensing current can be concentrated in the sensitive zone S not covered with the lead layers 234 to improve a change in voltage of the sensitive zone S, thereby improving the output characteristics of the spin valve thin film magnetic element 201.

Also, the shunt component of the sensing current can be decreased to express substantially no magnetoresistive effect in the dead zones covered with the lead layers 234. Therefore, the leakage magnetic field from the recording track of the magnetic recording medium is not detected in the dead zones N, thereby preventing side reading of the spin valve thin film magnetic element 101.

Like in the first embodiment, the ranges of the sensitive zone S and the dead zones N can be determined by the micro track profile method.

The method of manufacturing the spin valve thin film magnetic element 201 is the same as the spin valve thin film magnetic element 1 of the first embodiment except the bias layer forming step and the lead connecting portion forming step. Namely, in the bias layer forming step, the bias layers 232 are formed so that the upper surfaces 232a thereof are located at the same layer position as the fourth ferromagnetic pinned magnetic layer 209c. In the lead connecting portion forming step, irradiation with the etching particle beam is stopped when both side portions of the protecting layer 211 and the second antiferromagnetic layer 210 in the track width direction are etched.

Namely, in the bias layer forming step for the spin valve thin film magnetic element 201, the bias layers 232 are formed so that the upper surfaces 232a thereof are located at substantially the same layer position as the fourth ferromagnetic pinned layer 209c, as shown by two-dot chain lines in FIG. 7 or 13. Furthermore, the intermediate layers 233 are formed on the bias layers 332, as shown in FIG. 8 or 14.

In the lead connecting portion forming step, both side portions of the protecting layer 211 and the second antiferromagnetic layer 210 in the track width direction are etched to form the lead connecting portions 240 shown by two-dot chain lines in FIG. 9 or 16.

The other steps are performed in the same manner as the first embodiment to obtain the spin valve thin film magnetic element 201 show in FIG. 19.

### EXAMPLES

In the spin valve thin film magnetic element of the present invention, a strength distribution of reproduced output in the track width direction was examined.

Examination was carried out by using the spin valve thin film magnetic element 1 of the first embodiment shown in FIG. 1.

In the spin valve thin film magnetic element shown in FIG. 1, the track width Tw was 0.4 μm, and the width M of each lead connecting portion was 0.5 μm.

The laminate comprised the layers: underlying layer (Ta) 3/first antiferromagnetic layer (PtMn) 11/first ferromagnetic pinned layer (Co) 1.2/first nonmagnetic intermediate layer (Ru) 0.8/second ferromagnetic pinned layer (Co) 1.7/first nonmagnetic conductive layer (Cu) 2.2/first anti-diffusion layer (Co) 0.3/ferromagnetic free layer (NiFe) 2.4/second anti-diffusion layer (Co) 0.3/second nonmagnetic conductive layer (Cu) 2.2/third ferromagnetic pinned layer (Co) 1.7/second nonmagnetic intermediate layer (Ru) 0.8/fourth ferromagnetic pinned layer (Co) 1.2/second antiferromagnetic layer (PtMn) 11/protecting layer (Ta) 2 (wherein each numerical number represents the thickness by nm, and an element in parenthesis represents the component element of each layer).

The thickness of each lead layer (Cr) was about 100 nm, the thickness of each bias layer (CoPt) was 35 nm, the thickness of each bias underlying layer was 5 nm, and the thickness of each intermediate layer (Ta) was 5 nm.

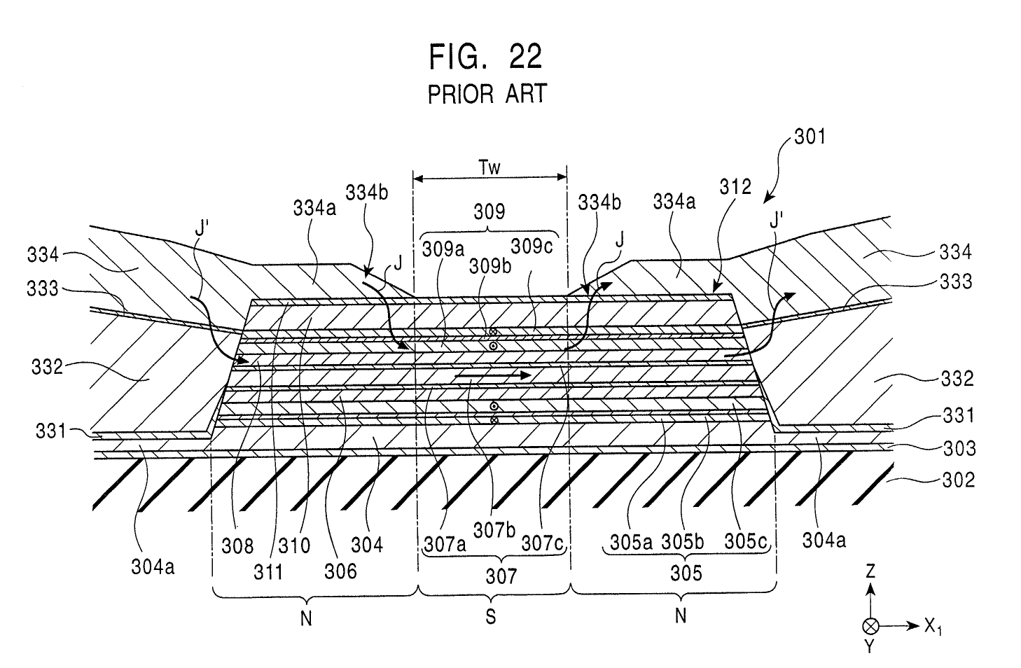

As a comparative example, the conventional spin valve thin film magnetic element shown in FIG. 22 was used. The laminate had the same structure as the spin valve thin film magnetic element of the example.

In the comparative example, the thickness of each lead layer (Cr) was about 100 nm, the thickness of each bias layer (CoPt) was 35 nm, the thickness of each bias underlying layer was 5 nm, and the thickness of each intermediate layer (Ta) was 5 nm.

In the spin valve thin film magnetic element of the comparative example, the track width Tw was 0.4 μm, and the width M of each of the pair of overlay portions in the track width direction was 0.5 μm.

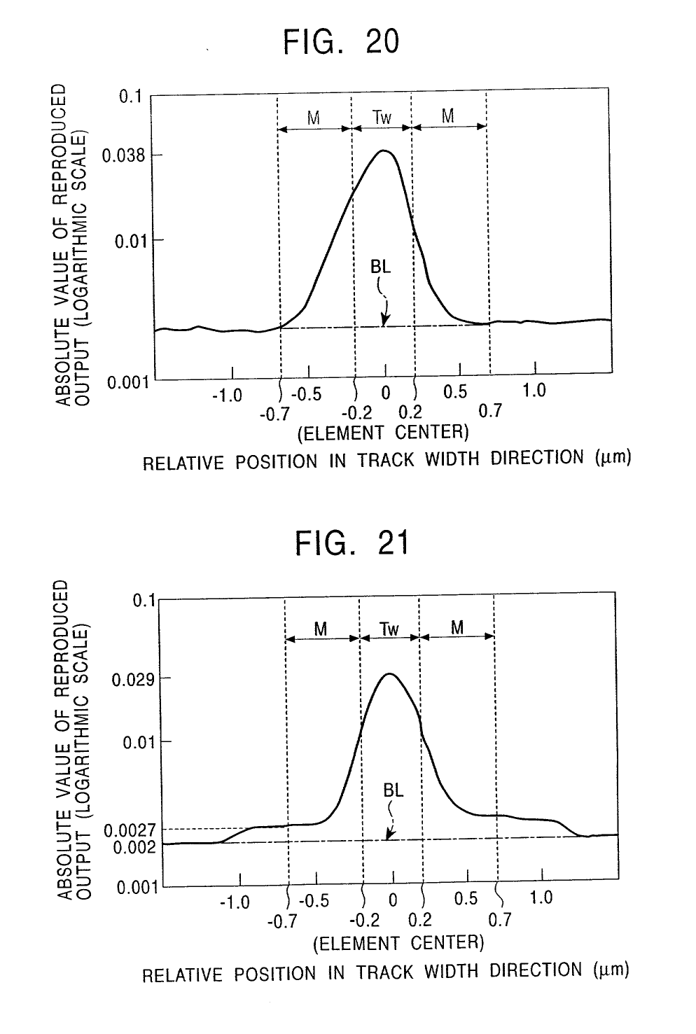

With respect to the spin valve thin film magnetic elements of the example and the comparative example, the strength distribution of a reproduced signal in the track width direction was measured by the micro track profile method shown in FIG. 4. The results are shown in FIGS. 20 and 21.

In FIGS. 20 and 21, the relative position in the track width direction with the element center as zero is shown on the abscissa, and the absolute value of signal strength of reproduced output is shown on the logarithmic scale on the ordinate.

Furthermore, in each of the graphs, Tw denotes the region where the optical track of the spin valve thin film magnetic element in the track width direction is formed, and M denotes the regions where the overlay portions (lead connecting portions) of the lead layers in the track width direction are formed. Also, BL denotes the profile base line.

FIG. 20 of the spin valve thin film magnetic element of the example indicates that in the vicinities of the lead connecting portion forming regions shown by M, the reproduced output value approaches the base line BL in the direction away from the element center, and converges to the base line BL at a distance of ±0.7 μm from the element center.

The positions at the distance of ±0.7 μm from the element center correspond to both ends of the laminate forming region in the track width direction. It is thus found that in the spin valve thin film magnetic element of the example, the recorded track is less detected in the dead zones of the laminate.

On the other hand, FIG. 21 of the conventional spin valve thin film magnetic element of the comparative example indicates that in the vicinities of the lead connecting portion forming regions shown by M, like in the example, the reproduced output value decreases in the direction away from the element center. However, even at a distance of ±0.7 μm from the element center, a signal having a relative reproduced output value of about 0.0027 is shown. This indicates that the reproduced output is obtained without converging to the base line.

The positions at the distance of ±0.7 μm from the element center correspond to both ends of the laminate forming region in the track width direction. It is thus found that in the conventional spin valve thin film magnetic element of the comparative example, the recorded track is detected in the dead zones of the laminate.

Also, the relative value of the reproduced output is about 0.038 at the center of the element of the example, while the relative value is about 0.029 at the center of the element of the comparative example. It is thus found that the reproduced output of the spin valve thin film magnetic element of the example is higher than the comparative example.

Therefore, it is found that the spin valve thin film magnetic element of the example shows high reproduced output, and low reproduced output in the dead zones of the element to decrease the probability of producing side reading, as compared with the conventional spin valve thin film magnetic element of the comparative example.

As described in detail above, in the spin valve thin film magnetic element of the present invention, lead layers are connected to lead connecting portions formed on both sides of a narrow antiferromagnetic layer in the track width direction, and thus a sensing current flows directly to a pinned magnetic layer from the lead layers without passing through the antiferromagnetic layer having high resistivity. Therefore, a shunt component of the sensing current which flows to a laminate through bias layers can be decreased.

As a result, the sensing current can be concentrated in the central portion of the laminate which is not covered with the lead layers to improve a change in voltage in this portion, thereby improving the output characteristics of the spin valve thin film magnetic element.

Since the shunt component of the sensing current can be decreased, the portions (both sides portions of the laminate in the track width direction), which are covered with the lead layers, exhibit substantially no magnetoresistive effect to avoid the detection of a leakage magnetic field from a recording track of a magnetic recording medium in those portions. It is thus possible to prevent side reading in the spin valve thin film magnetic element.

When the lead layers are connected to the lead connecting portions which are formed on both sides of narrow antiferromagnetic layer and pinned magnetic layer in the track width direction, the sensing current flows directly to a nonmagnetic conductive layer having low resistivity, thereby further decreasing the shunt component of the sensing current and effectively suppressing side reading of the spin valve thin film magnetic element.

When the lead layers are connected to the lead connecting portions which are formed on both sides of narrow antiferromagnetic layer and pinned magnetic layer and a narrow portion of a nonmagnetic conductive layer in the track width direction, the sensing current flows directly to the nonmagnetic conductive layer having low resistivity, thereby further decreasing the shunt component of the sensing current and more effectively suppressing side reading of the spin valve thin film magnetic element.

Also, in the spin valve thin film magnetic element of the present invention, the lead connecting portions respectively comprise notches so that the lead layers are respectively fitted into the notches for connection, and thus the steps between the laminate and the lead layers can be decreased to decrease the gap width of the spin valve thin film magnetic element. When an insulating layer is further laminated on the spin valve thin film magnetic element, there is no probability of producing pin holes or the like in the insulating layer, thereby increasing the insulation performance of the spin valve thin film magnetic element.

Since the width of each of the lead connecting portions is in the range of 0.03 to 0.5 μm, the contact area between the lead layers and the laminate in the lead connecting portions can be increased to cause the sensing current to efficiently flow to the laminate.

In the spin valve thin film magnetic element of the present invention, the bias layers are arranged at the same layer position as the free magnetic layer, and thus a strong bias magnetic field can be easily applied to the free magnetic layer to easily put the free magnetic layer in the single magnetic domain state, thereby decreasing Barkhousen noise.

In the spin valve thin film magnetic element of the present invention, only the pair of lead layers are connected to the pair of the lead connecting portions, and thus the contact area between the lead layers and the laminate in the lead connecting portions can be increased to decrease the shunt component and further improve the output characteristics of the spin valve thin film magnetic element.

In the spin valve thin film magnetic element of the present invention, the pinned magnetic layer exhibits a so-called synthetic ferrimagnetic pinned state, and thus the magnetization direction of the pinned magnetic layer can be strongly pinned to stabilize the pinned magnetic layer.

In the spin valve thin film magnetic element of the present invention, the pair of lead layers are formed to extend from both sides of the laminate in the track width direction to the dead zones thereof and to adhere to the laminate. Therefore, the sensing current flowing from the lead layers can be concentrated in the sensitive zone located between the pair of lead layers, and thus the width of the sensitive zone between the pair of lead layers can be caused to correspond to the track width of the spin valve thin film magnetic element.

Therefore, the track width of the spin valve thin film magnetic element can be defined by the distance between the pair of the lead layers adhered to the dead zones, and narrowing of the track of the spin valve thin film magnetic element can be achieved by decreasing the distance between the lead layers.

A method of manufacturing the spin valve thin film magnetic element of the present invention comprising the laminate forming step of irradiating a substrate with an etching particle beam in the direction at an angle θ₁ to form a laminate having a substantially trapezoidal sectional shape, and the lead connecting portion forming step of irradiating the substrate with another etching particle beam in the direction at an angle θ₃ (θ₁>θ₃) to form a pair of lead connecting portions corresponding to the notches of a lift off resist. Therefore, the laminate and the lead connecting portions can be formed by using only one lift off resist, thereby shortening the manufacturing process of the spin valve thin film magnetic element.

Also, the antiferromagnetic layer is etched to form the lead connecting portions so that the lead layers are connected to the lead connecting portions, and thus the lead layers can be connected directly to the pinned magnetic layer. It is thus possible to manufacture a spin valve thin film magnetic element in which the sensing current can be applied to the laminate without flowing to the antiferromagnetic layer.

Another method of manufacturing the spin valve thin film magnetic element of the present invention comprises forming a laminate having a substantially trapezoidal sectional shape by using a first lift off resist, and forming lead connecting portion by using a second lift off resist. Therefore, the width of the laminate in the track width direction and the width of each of the lead connecting portions in the track width direction can be precisely controlled. It is thus possible to easily manufacture a spin valve thin film magnetic element having the low probability of producing side reading with a narrow track.

In the method of manufacturing the spin valve thin film magnetic element of the present invention, the sputtered particle type is analysis by secondary ion mass spectroscopic analysis to determine the end point of etching for forming the lead connecting portions. Therefore, the precision of etching for forming the lead connecting portions can be improved to permit the precise formation of the lead connecting portions.

What is claimed is:

1. A spin valve thin film magnetic element comprising:
a pair of nonmagnetic conductive layers, a pair of pinned magnetic layers, and a pair of antiferromagnetic layers for respectively pinning the magnetization directions of the pair of pinned magnetic layers, which are laminated in turn on both sides of a free magnetic layer in the thickness direction to form a laminate on a substrate;
a pair of bias layers located on both sides of the laminate in the track width direction, for orienting the magnetization direction of the free magnetic layer in the direction crossing the magnetization direction of each of the pinned magnetic layers; and
a pair of lead layers laminated on the bias layers, for supplying a sensing current to the laminate;
wherein of the pair of antiferromagnetic layers, at least the antiferromagnetic layer apart from the substrate is made narrower than the free magnetic layer in the track width direction to form lead connecting portions of the laminate on both sides of the narrow antiferromagnetic layer in the track width direction; and
the pair of lead layers are extended from both sides of the laminate in the track width direction to the center of the laminate and connected to the laminate through the pair of lead connecting portions.

2. A spin valve thin film magnetic element according to claim 1, wherein in addition to the narrow antiferromagnetic layer, at least a portion or the whole of the pinned magnetic layer adjacent to the antiferromagnetic layer is made narrower than the free magnetic layer to form lead connecting portions of the laminate on both sides of the narrow antiferromagnetic layer and pinned magnetic layer, and the pair of lead layers are extended from both sides of the laminate in the track width direction to the center thereof and connected to the laminate through the pair of lead connecting portions.

3. A spin valve thin film magnetic element according to claim 1, wherein in addition to the narrow antiferromagnetic layer, the pinned magnetic layer adjacent to the narrow antiferromagnetic layer and a portion the nonmagnetic conductive layer adjacent to the pinned magnetic layer are made narrower than the free magnetic layer to form lead connecting portions of the laminate on both sides of the narrow antiferromagnetic layer, pinned magnetic layer and nonmagnetic conductive layer, and the pair of lead layers are extended from both sides of the laminate in the track width direction to the center thereof and connected to the laminate through the pair of lead connecting portions.

4. A spin valve thin film magnetic element according to claim 1, wherein the pair of the connecting portions respectively comprise notch portions formed on the side apart from the substrate to be located at both ends of the laminate in the track width direction, and the width of each of the lead connecting portions in the track width direction is in the range of 0.03 to 0.5 μm.

5. A spin valve thin film magnetic element according to claim 1, wherein the pair of bias layers are adjacent to the free magnetic layer to be located at the same layer position as at least the free magnetic layer, and the upper surfaces of the pair of bias layers are joined to the laminate at positions nearer to the substrate than the lead connecting portions so that only the pair of lead layers are connected to the pair of lead connecting portions.

6. A spin valve thin film magnetic element according to claim 1, wherein each of the pair of the pinned magnetic layers comprises a laminate of at least two ferromagnetic layers and a nonmagnetic intermediate layer inserted between these ferromagnetic layers, and the magnetization directions of the adjacent ferromagnetic layers are antiparallel to each other to bring the whole pinned magnetic layer into a ferrimagnetic state.

7. A spin valve thin film magnetic element according to claim 6, wherein each of the pair of the pinned magnetic layers comprises a laminate of two ferromagnetic layers and a nonmagnetic intermediate layer inserted between these ferromagnetic layers, and the magnetization directions of the adjacent ferromagnetic layers are antiparallel to each other to bring the whole pinned magnetic layer into a ferrimagnetic state.

8. A spin valve thin film magnetic element according to claim 1, wherein of the pair of antiferromagnetic layers, the antiferromagnetic layer located near to the substrate is formed to extend beyond the free magnetic layer in the track width direction so that the bias layers are laminated on the extensions of the antiferromagnetic layer.

9. A spin valve thin film magnetic element according to claim 1, wherein the bias layers are laminated, through bias underlying layers made of Ta or Cr, on the extensions of the antiferromagnetic layer located near to the substrate.

10. A spin valve thin film magnetic element according to claim 1, wherein intermediate layers made of Ta or Cr are respectively laminated between the bias layers and the lead layers.

11. A spin valve thin film magnetic element according to claim 1, wherein each of the pair of antiferromagnetic layers comprises any one of XMn alloys and PtX′Mn alloys (wherein X represents one element selected from Pt, Pd, Ir, Rh, Ru, and Os, and X′ represents at least one element selected from Pd, Cr, Ru, Ni, Ir, Rh, Os, Au, Ag, Ne, Ar, Xe and Kr).

12. A spin valve thin film magnetic element according to claim 1, wherein the laminate comprises a central sensitive zone which has high reproduction sensitivity and can substantially exhibit a magnetoresistive effect, and dead zones which are formed on both sides of the sensitive zone in the track width direction and have low reproduction sensitivity, and which cannot substantially exhibit the magnetoresistive effect; and
wherein the pair of lead connecting portions formed at both ends of the laminate are formed on the dead zones of the laminate, and the pair of lead layers are formed to extend from both sides of the laminate in the track width direction to the dead zones and to adhere to the laminate.

13. A method of manufacturing a spin valve thin film magnetic element comprising:
the laminated film forming step of laminating in turn an antiferromagnetic layer, a pinned magnetic layer, a nonmagnetic conductive layer, a free magnetic layer, another nonmagnetic conductive layer, another pinned magnetic layer and another antiferromagnetic layer on a substrate to form a laminated film;
the resist forming step of forming a lift off resist on the laminated film, the resist comprising a butting surface in contact with the laminated film and both side surfaces holding the contact surface therebetween, and a pair of notches provided on both sides of the butting surface in the track width direction to be located between the butting surface and both side surfaces;
the laminate forming step of entirely or partially etching the laminated film outside both side surfaces of the lift off resist in the track width direction by irradiating the laminated film with an etching particle beam in the direction at an angle θ₁ with the substrate to form a laminate having a substantially trapezoidal sectional shape;
the bias layer forming step of depositing other sputtered particles on both sides of the laminate in the direction at an angle θ₂ (however, θ₂>θ₁) of with the substrate to laminate a pair of bias layers to the same layer position as at least the free magnetic layer;
the lead connecting portion forming step of etching at lest the portions of the other antiferromagnetic layer corresponding to the pair of notches by irradiating the laminate with another etching particle beam in the direction at an angle θ₃ (however, θ₁>θ₃) with the substrate to form a pair of lead connecting portions; and
the lead layer forming step of depositing still other sputtered particles on the laminate and the bias layers in the direction at an angle θ₃ with the substrate to form a pair of lead layers which extend from both sides of the laminate in the track width direction to the center thereof to be connected to the laminate through the pair of lead connecting portions.

14. A method of manufacturing a spin valve thin film magnetic element according to claim 13, wherein in the lead connecting portion forming step, in addition to the portions of the other antiferromagnetic layer corresponding to the notches, the other pinned magnetic layer is partially or entirely etched corresponding to the notches to form a pair of lead connecting portions.

15. A method of manufacturing a spin valve thin film magnetic element according to claim 13, wherein in the lead connecting portion forming step, the other antiferromagnetic layer and the other pinned magnetic layer are etched corresponding to the pair of notches, and the other nonmagnetic conductive layer is partially etched corresponding to the pair of notches to form a pair of lead connecting portions.

16. A method of manufacturing a spin valve thin film magnetic element according to claim 13, wherein in the laminate forming step, the laminated film is etched outside both side surfaces of the lift off resist in the track width direction to leave a portion of the antiferromagnetic layer adjacent to the substrate.

17. A method of manufacturing a spin valve thin film magnetic element according to claim 13, wherein the bias layer forming step comprises forming the bias layers and depositing sputtered particles at the angle θ₁ to form intermediate layers made of Ta or Cr on the bias layers, and the lead connecting portion forming step comprises forming the lead connecting portions and, at the same time, etching a portion of the intermediate layers.

18. A method of manufacturing a spin valve thin film magnetic element according to claim 13, wherein the angle θ₁ is in the range of 60 to 85°, the angle θ₂ is in the range of 70 to 90°, and the angle θ₃ is in the range of 40 to 70°.

19. A method of manufacturing a spin valve thin film magnetic element according to claim 13, wherein the widths of the pair of lead connecting portions in the track width direction are respectively defined by the widths of the notches of the lift off resist in the track width direction.

20. A method of manufacturing a spin valve thin film magnetic element comprising:
the laminated film forming step of laminating in turn an antiferromagnetic layer, a pinned magnetic layer, a nonmagnetic conductive layer, a free magnetic layer, another nonmagnetic conductive layer, another pinned magnetic layer and another antiferromagnetic layer on a substrate to form a laminated film;
the first resist forming step of forming a first lift off resist on the laminated film, the first resist comprising a butting surface in contact with the laminated film and both side surfaces holding the contact surface therebetween, and a pair of notches provided on both sides of the butting surface in the track width direction to be located between the butting surface and both side surfaces;
the laminate forming step of entirely or partially etching the laminated film outside both side surfaces of the first lift off resist in the track width direction by irradiating the laminated film with an etching particle beam in the direction at an angle θ₄ with the substrate to form a laminate having a substantially trapezoidal sectional shape;
the bias layer forming step of depositing other sputtered particles on both sides of the laminate in the direction at an angle θ₅ (however, θ₅>θ₄) with the substrate to laminate a pair of bias layers to the same layer position as at least the free magnetic layer;
the second lift off resist forming step of removing the first lift off resist and forming a second lift off resist at substantially the center of the top of the laminate, the second resist comprising a butting surface narrower than the butting surface of the first lift off resist and both side surfaces holding the narrow butting surface therebetween, and a pair of notches provided on both sides of the narrow butting surface in the track width direction to be located between the butting surface and both side surfaces;
the lead connecting portion forming step of etching at least the portions of the other antiferromagnetic layer outside both side surfaces of the second lift off resist in the track width direction by irradiating the laminate with another etching particle beam in the direction at an angle θ₆ with the substrate to form a pair of lead connecting portions; and
the lead layer forming step of depositing still other sputtered particles on the laminate and the bias layers in the direction at an angle θ₆ with the substrate to form a pair of lead layers which extend from both sides of the laminate in the track width direction to the center thereof to be connected to the laminate through the pair of lead connecting portions.

21. A method of manufacturing a spin valve thin film magnetic element according to claim 20, wherein in the lead connecting portion forming step, the other antiferromagnetic layer is etched outside both side surfaces of the second lift off resist in the track width direction, and the other pinned magnetic layer is partially or entirely etched outside both side surfaces of the second lift off resist in the track width direction to form a pair of lead connecting portions.

22. A method of manufacturing a spin valve thin film magnetic element according to claim 20, wherein in the lead connecting portion forming step, the other antiferromagnetic layer and the other pinned magnetic layer are etched outside both side surfaces of the second lift off resist in the track width direction, and the other nonmagnetic conductive layer is partially etched outside both side surfaces of the second lift off resist in the track width direction to form a pair of lead connecting portions.

23. A method of manufacturing a spin valve thin film magnetic element according to claim 20, wherein in the laminate forming step, the laminated film is etched outside both side surfaces of the first lift off resist in the track width direction to leave a portion of the antiferromagnetic layer adjacent to the substrate.

24. A method of manufacturing a spin valve thin film magnetic element according to claim 20, wherein the bias layer forming step comprises forming the bias layers and depositing sputtered particles at the angle θ₄ to laminate intermediate layers made of Ta or Cr on the bias layers, and the lead connecting portion forming step comprises partially etching the intermediate layers at the same time as formation of the lead connecting portions.

25. A method of manufacturing a spin valve thin film magnetic element according to claim 20, wherein the angle θ₄ is in the range of 50 to 85°, the angle θ₅ is in the range of 60 to 90°, and the angle θ₆ is in the range of 50 to 90°.

26. A method of manufacturing a spin valve thin film magnetic element according to claim 20, wherein the widths of the pair of lead connecting portions in the track width direction are respectively defined by the relative distances between side positions of the laminate and the side positions of the second lift off resist.

27. A method of manufacturing a spin valve thin film magnetic element according to claim 13, wherein in the lead connecting portion forming step, the sputtered particle type discharged from the laminate during etching is analyzed by secondary ion mass spectroscopic analysis to detect the end point of etching.

28. A method of manufacturing a spin valve thin film magnetic element according to claim 20, wherein in the lead connecting portion forming step, the sputtered particle types discharged from the laminate during etching is analyzed by secondary ion mass spectroscopic analysis to detect the end point of etching.
